(19) United States
(12) Patent Application Publication
(10) Pub. No.: US 2015/0120870 A1
(43) Pub. Date: Apr. 30, 2015

(54) MEDIA DISTRIBUTION NETWORK, ASSOCIATED PROGRAM PRODUCTS, AND METHODS OF USING THE SAME

(71) Applicant: Joseph Schuman, New York, NY (US)

(72) Inventor: Joseph Schuman, New York, NY (US)

(21) Appl. No.: 14/524,252

(22) Filed: Oct. 27, 2014

Related U.S. Application Data
(60) Provisional application No. 61/895,671, filed on Oct. 25, 2013.

(51) Int. Cl. H04L 29/08; G06F 17/30; H04L 12/26

(52) U.S. Cl. CPC H04L 67/06; H04L 43/0876; G06F 17/30997
USPC 709/217; 709/224

(57) ABSTRACT

A media server is disclosed, and includes one or more processors, one or more modules of non-transitory computer-readable memory, a count module, a publishing module, and a timer module. The count module is configured to determine a number of electronic connections associated with a plurality of units of media content. The publishing module is configured to transmit for display a unit of media content of the plurality of units of media content associated with a highest number of electronic connections onto one or more subscriber devices of a plurality of subscriber devices electronically connected to the media server. The timer module is configured to instruct the count module to update a determination of a number of electronic connections associated with the plurality of units of media content at one or more predetermined intervals.

### CROSS-REFERENCE TO RELATED APPLICATION

This application claims priority to and the benefit of U.S. Provisional Patent Application No. 61/895,671, filed on Oct. 25, 2013, the entire contents of which are incorporated by reference herein.

### FIELD OF INVENTION

The present invention generally relates to a media distribution network, associated program products, and methods of using the same.

### SUMMARY

According to an exemplary embodiment of the present invention, a media server is disclosed, and includes one or more processors, one or more modules of non-transitory computer-readable memory, a count module, a publishing module, and a timer module. The one or more modules of non-transitory computer-readable memory store a set of instructions, and are electronically coupled with the one or more processors to implement at least one instruction of the set of instructions. The count module is configured to determine a number of electronic connections associated with a plurality of units of media content. The publishing module is configured to transmit for display a unit of media content of the plurality of units of media content associated with a highest number of electronic connections onto one or more subscriber devices of a plurality of subscriber devices electronically connected to the media server. The timer module is configured to instruct the count module to update a determination of a number of electronic connections associated with the plurality of units of media content at one or more predetermined intervals.

In embodiments, the media server further comprises a ranking module configured to modify count data output by the count module.

In embodiments, the ranking module is configured to apply a ranking algorithm to modify count data output by the count module.

In embodiments, the ranking algorithm is configured to exclude one or more electronic connections from a determination of the count module.

In embodiments, the media server further comprises an encoder module configured to convert the at least one unit of media content of the plurality of units of media content from a first format to a second, different format.

In embodiments, the media server further comprises a media storage module configured to store at least one unit of media content of the plurality of units of media content.

In embodiments, the media server further comprises a sorting module configured to assign at least one unit of media content of the plurality of units of media content to one or more category.

In embodiments, the sorting module is configured to assign at least one unit of media content of the plurality of units of media content to one or more category based upon metadata associated with the at least one unit of media content.

In embodiments, the one or more category is chosen from a group consisting of: title, keyword, genre, creation date, creation location, and length.

In embodiments, the media server further comprises a communication module for sending a notification to at least one subscriber device of the plurality of subscriber devices.

In embodiments, the plurality of subscriber devices is electronically connected with the media server across a data network.

In embodiments, at least one predetermined time interval of the one or more predetermined time intervals is 15 minutes.

In embodiments, the count module is configured to retrieve count data associated with a number of electronic connections associated with a unit of media content from one or more third party media content providers.

In embodiments, the media server further comprises a commercial content module configured to transmit for display one or more units of commercial media content adjacent to the at least one unit of media content.

In an exemplary embodiment of the present invention, a computer-implemented method is disclosed, and comprises: (a) retrieving, by a media server having one or more processors configured to read one or more instructions of a set of instructions stored on a non-transitory computer-readable medium, a plurality of units of media content; (b) determining, by a count module of the media server, a number of electronic connections to each unit of media content of the plurality of units of media content; and (c) transmitting, by a publishing module of the media server, a unit of media content having the highest number of electronic connections for display on at least one subscriber device electronically connected to the media server.

In embodiments, the method further comprises the step of applying, by a ranking module of the media server, a ranking algorithm to transform data associated with a determination by the count module of the media server.

In embodiments, the ranking algorithm includes excluding one or more electronic connections from a determination by the count module of the media server.

### BRIEF DESCRIPTION OF THE DRAWINGS

Various exemplary embodiments of this invention will be described in detail, with reference to the following figures, wherein:

FIG. 1A is a schematic diagram of a media distribution network according to an exemplary embodiment of the present invention;

FIG. 1B is a schematic diagram of a user device associated with the media distribution network of FIG. 1A according to an exemplary embodiment of the present invention;

FIG. 1C is a schematic diagram of a media server associated with the media distribution network of FIG. 1A according to an exemplary embodiment of the present invention;

FIG. 1D is a process flow illustrating a process of a media server of the media distribution network of FIG. 1A according to an exemplary embodiment of the present invention;

FIG. 1E is a flow chart illustrating a process of a media server of the media distribution network of FIG. 1A according to an exemplary embodiment of the present invention;

FIG. 1F is a graphical user interface associated with a program product of the media server of the media distribution network of FIG. 1A according to an exemplary embodiment of the present invention;

FIG. 1G is a schematic diagram of the media distribution network of FIG. 1A according to an alternative embodiment of the present invention;

FIG. 2A is a schematic diagram of a media distribution network according to an exemplary embodiment of the present invention;

FIG. 2B is a schematic diagram of a media server associated with the media distribution network of FIG. 2A according to an exemplary embodiment of the present invention;

FIG. 2C is a process flow illustrating a process of a media server of the media distribution network of FIG. 2A according to an exemplary embodiment of the present invention;

FIG. 2D is a flow chart illustrating a process of a media server of the media distribution network of FIG. 2A according to an exemplary embodiment of the present invention;

FIG. 2E is a graphical user interface associated with a program product of the media server of the media distribution network of FIG. 2A according to an exemplary embodiment of the present invention;

FIG. 3A is a schematic diagram of a media distribution network according to an exemplary embodiment of the present invention;

FIG. 3B is a schematic diagram of a user device associated with the media distribution network of FIG. 3A according to an exemplary embodiment of the present invention;

FIG. 3C is a process flow illustrating a process of a media server of the media distribution network of FIG. 3A according to an exemplary embodiment of the present invention;

FIG. 3D is a flow chart illustrating a process of a media server of the media distribution network of FIG. 3A according to an exemplary embodiment of the present invention; and

FIG. 3E is a schematic diagram of the media distribution network of FIG. 3A according to an alternative embodiment of the present invention;

### DETAILED DESCRIPTION

The present invention generally relates to a media distribution network, associated program products, and methods of using the same.

In embodiments, the present invention is directed to a media distribution network having a media server that facilitates the distribution of media content to a plurality of subscriber devices connected across the media distribution network. Such a media distribution network provides a centralized platform to which media content can be uploaded and/or viewed by a plurality of subscribers.

Media content may be in the form of data associated with audible sounds and/or visual images, such as two-dimensional content, for example, still images or video, and/or three-dimensional content, for example, holographic displays. Media content described in exemplary embodiments herein may be live, e.g., streaming or substantially real-time content, or may be pre-recorded and/or stored for later distribution. In exemplary embodiments described herein, a unit of media content can be, for example, a movie, a clip, a song, broadcast, and/or a portion thereof, to name a few.

Program products associated with the media distribution network may include websites or other electronic platforms such as computer software applications that can be run on one or more subscriber devices having one or more non-transitory storage mediums upon which instructions can be read, for example, by one or more processors or other computing devices, so that media content can be displayed on the one or more subscriber devices. In embodiments, media content can be generated from subscriber devices and uploaded to the media distribution network for viewing by other subscribers.

In embodiments, the media distribution network is configured to periodically update media content being displayed based upon the popularity of the media content across one or more associated third party media content providers. In this regard, the media distribution network may provide a platform upon which creators and/or providers of media content can enter a competitive environment in which they vie for the substantial viewership (and/or other metric of popularity) across the plurality of subscriber devices connected to the media distribution network.

In embodiments, one or more incentives may be provided for generators of media content that garner the substantial viewership of the plurality of subscriber devices connected to the media distribution network. For example, a monetary award or voucher for goods and/or services can be provided to a creator and/or provider of a most popular unit of media content as determined by the media distribution network. In embodiments, the media distribution network may provide other opportunities for financial gain for content providers or third party advertisers, for example, by featuring advertiser-sponsored video or other modalities of commercial advertisements.

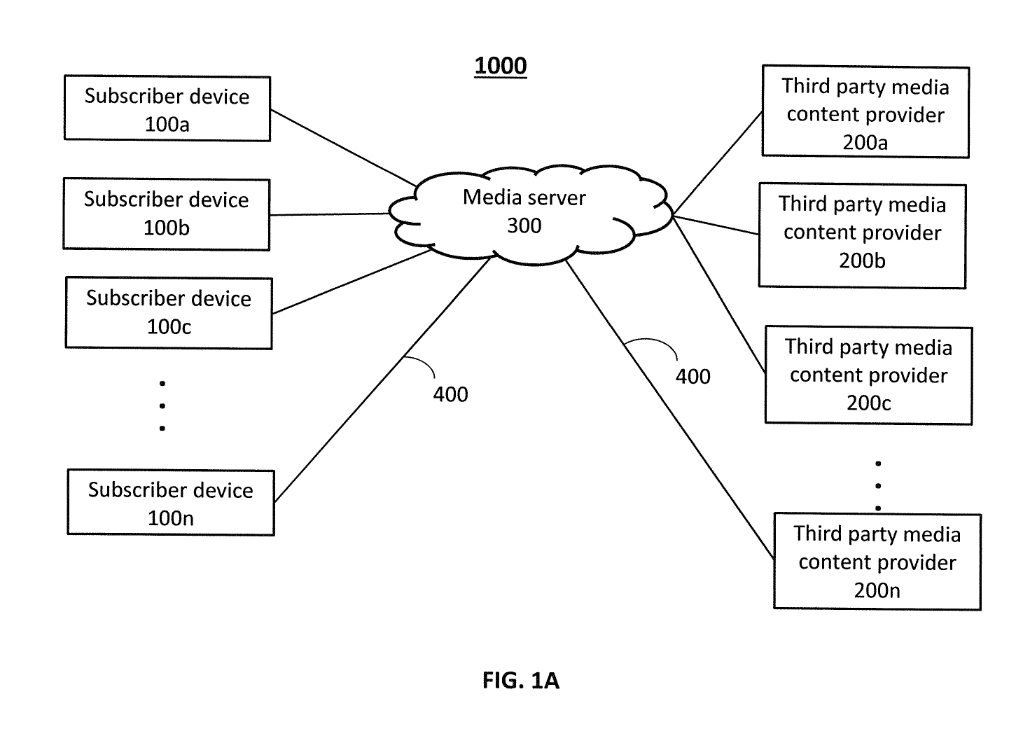

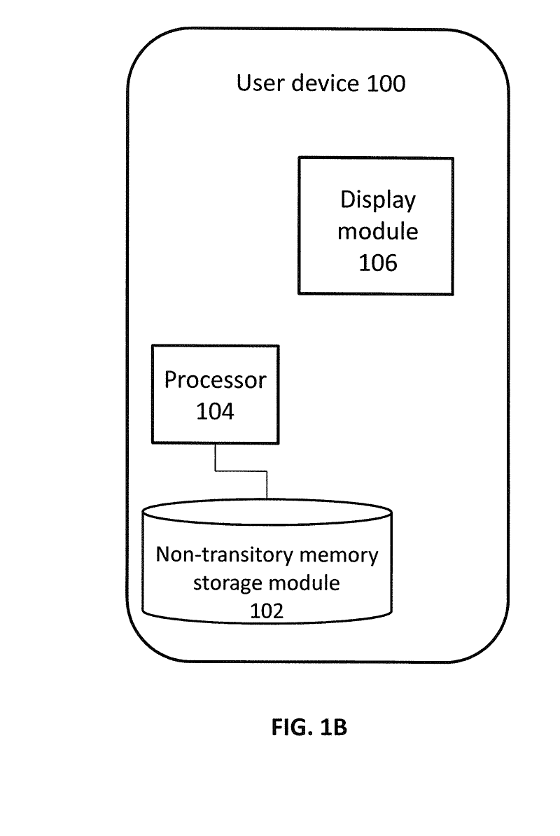

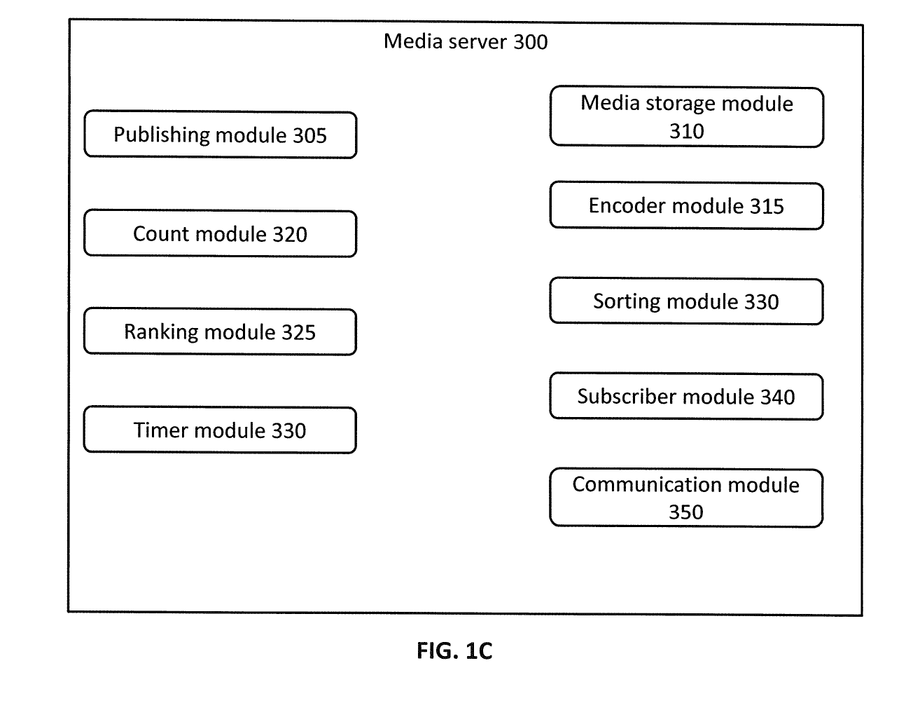

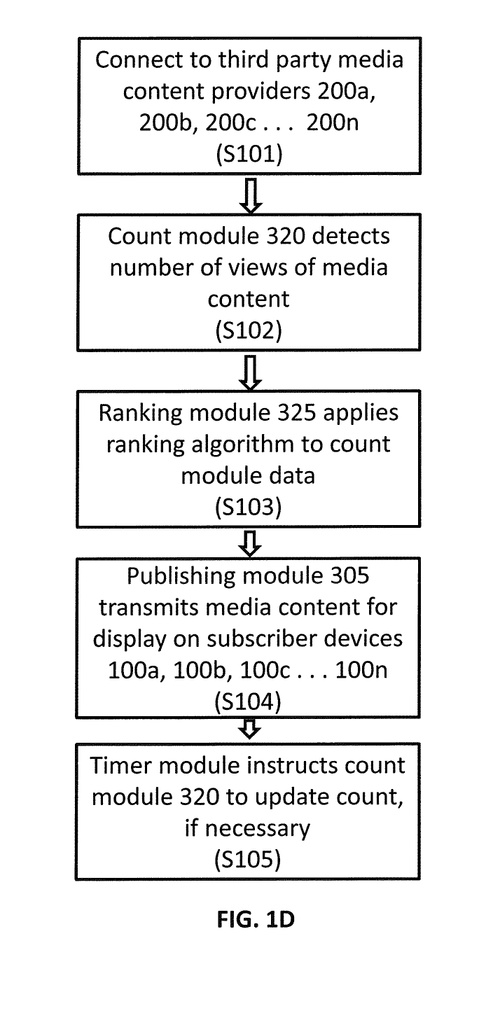

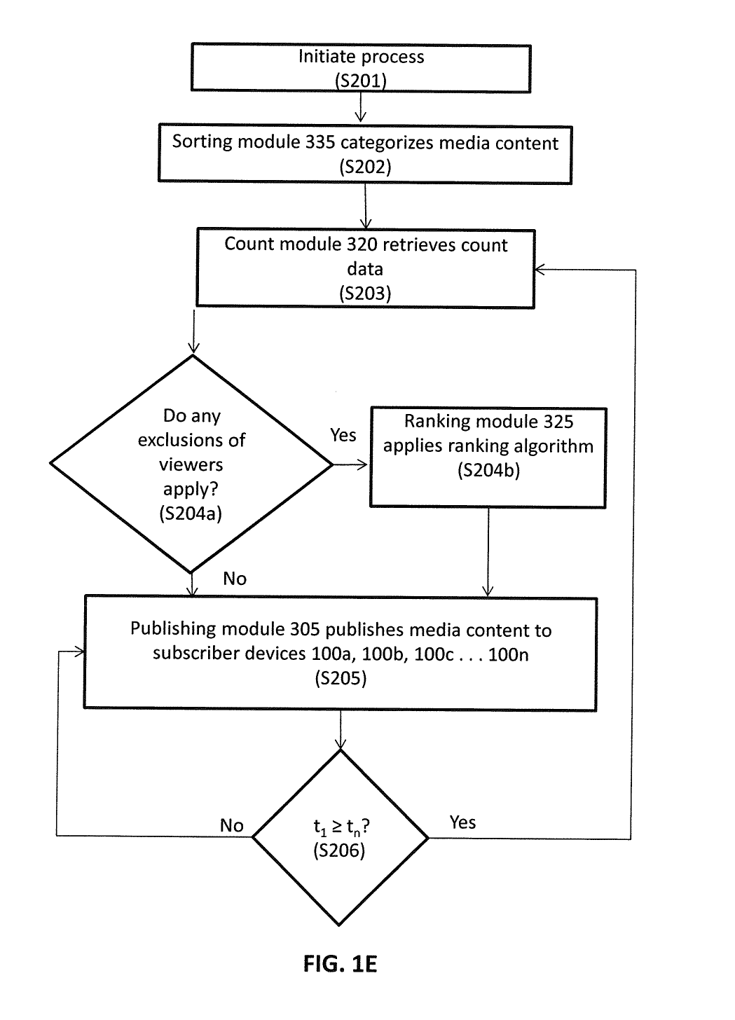

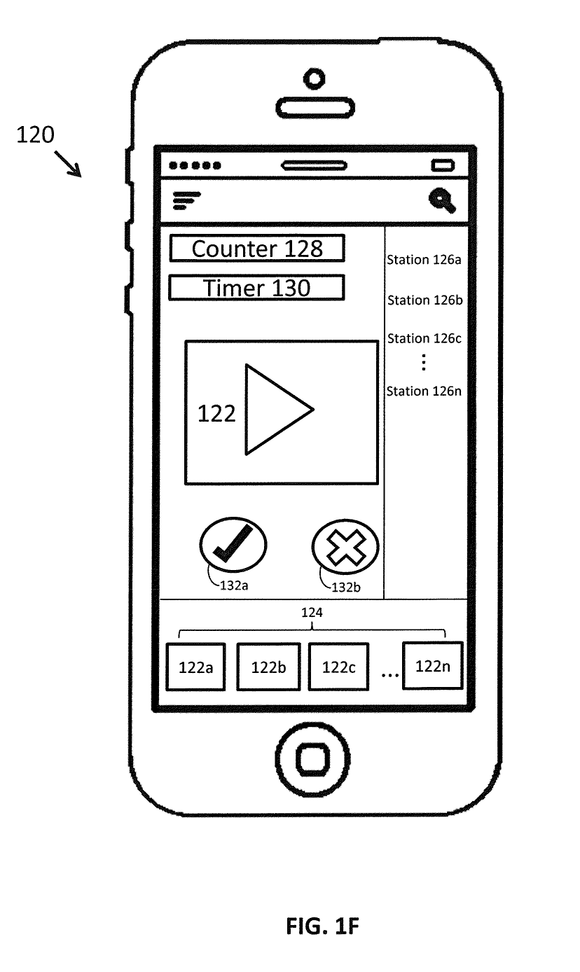

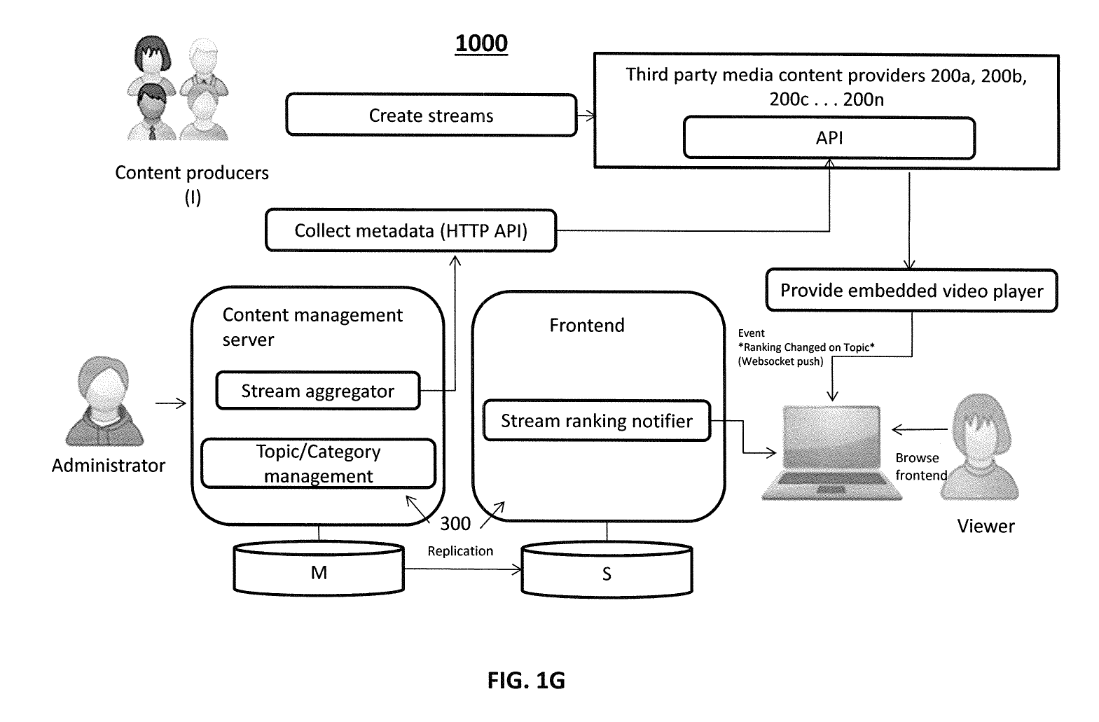

Turning to FIG. 1A, an exemplary embodiment of a media distribution network is generally designated 1000. Media distribution network 1000 includes a plurality of subscriber devices 100a, 100b, 100c . . . 100n and a plurality of third party media content providers 200a, 200b, 200c . . . 200n in electronic communication with a media server 300. In embodiments, media distribution network 1000 may include a plurality of subscriber devices 100a, 100b, 100c . . . 100n and may be devoid of a plurality of third party media content providers 200a, 200b, 200c . . . 200n, or vice-versa.

Subscriber devices 100a, 100b, 100c . . . 100n may be electronic devices configured to display and/or project media content in a format that is visible, audible, and/or otherwise capable of being received by a human operator of the subscriber device. In embodiments, such user devices may include smartphones, tablet computers, laptop computers, desktop computers, and/or wearable computers such as smartwatches or other bodily-mounted computing devices, e.g., Google Glass™, to name a few. In embodiments, subscriber devices 100a, 100b, 100c . . . 100n may be capable of generating media content for transmission across media distribution network 1000, as described further herein.

Third party media content providers 200a, 200b, 200c . . . 200n may be third party services, e.g., websites, computer program applications, and/or mobile devices applications, to name a few, that provide a platform for viewing media content. Examples of third party media content providers may include, for example, YouTube, Vimeo, Ustream, Justin.tv, Stickam, BlogTV, Kyte, Veetle, Yaika, Make.tv, and/or Glomera, to name a few. In embodiments, a third party media content provider may be an entity whose operations are not primarily web-based, for example, a network television entity (which may be terrestrial or web-based), a social media platform (such as Facebook, Instagram, Vine, or MySpace), a streaming video service (such as Netflix, Hulu, or Amazon Prime), satellite media content provider (such as Comcast or Time Warner), video news aggregators (such as Flipboard, Feedly, or Watchup), digital video recorded (DVR'd) media content, and/or electronic news publishers (such as Huffington Post), to name a few.

In embodiments, third party media content providers may be sellers and/or distributors of wholly or partially downloadable media content (as opposed to streaming media content), such as media content purchased from the iTunes Store, Google Play Store, or Amazon Store, to name a few.

Still referring to FIG. 1A, the plurality of subscriber devices 100a, 100b, 100c . . . 100n and the plurality of third party media content providers 200a, 200b, 200c . . . 200n are in electronic communication with media server 300 across a data network 400. Data network 400 may be a wired and/or wireless data communication system, such as the Internet, a mobile (e.g., cellular or satellite), and/or a local intranet, to name a few. In embodiments, data network 400 may include a mesh network, e.g., a network formed of one or more local modalities of data communication, for example, Wi-Fi, infrared, and/or Bluetooth data transmission, to name a few.

Accordingly, subscriber devices 100a, 100b, 100c . . . 100n, third party media content providers 200a, 200b, 200c . . . 200n, and/or media server 300 may include interface software and/or hardware, such as that necessary to support wired or wireless and connections and/or communications for connection to media server 300 across date network 400. Wired connections may be adapted for use with cable, POTS (telephone), fiber (such as Hybrid Fiber Coaxial), xDSL, to name a few, and wired connections may use coaxial cable, fiber, copper wire (such as twisted pair copper wire), and/or combinations thereof, to name a few. Wireless connections may include any cellular or cellular data connections (e.g., digital cellular, PCS, CDPD, GPRS, CDMA2000, Ev-DO, HSPA, UMTS, to name a few), Bluetooth, Wi-Fi, radio, satellite, infrared connections, and/or other electromagnetic waves, to name a few. Interface hardware and/or software, which may be used to communicate over wired and/or wireless connections, may comprise any of Ethernet interfaces (e.g., supporting a TCP/IP stack), X.25 interfaces, T1 interfaces, and/or antennas, to name a few. One or more communications portals (e.g., a communications portal of a device) may handle, process, support, and/or perform any wired and/or wireless communications and may comprise hardware and/or software.

Referring additionally to FIG. 1B, a schematic diagram of a subscriber device 100 is illustrated. Subscriber device 100 as described herein may be representative of or similarly configured to any of subscriber devices 100a, 100b, 100c . . . 100n. In embodiments, one or more of subscriber devices 100a, 100b, 100c . . . 100n may have different a configuration than subscriber device 100.

Subscriber device 100, as described above, may be a portable electronic device configured to display and/or project media content in a format that is visible, audible, and/or otherwise capable of being received by a human operator of the subscriber device. In embodiments, such user devices may include smartphones, tablet computers, laptop computers, desktop computers, and/or wearable computers such as smartwatches or other bodily-mounted computing devices, e.g., Google Glass™ or a GoPro™ camera device, to name a few.

In embodiments, subscriber device 100 may be configured to run a program product, e.g., a software program or other computer code associated with media server 300. Accordingly, subscriber device 100 may include one or more non-transitory memory storage modules 102 upon which computer-readable instructions may be read. In embodiments, subscriber device 100 may include one or more processors 104 electronically coupled with the one or more non-transitory memory storage modules 102 so that a software program or other computer code associated with media server 300 can be run on subscriber device 100.

As shown, subscriber device 100 as shown may include one or more software modules for handling various processes associated with the generation and/or transmission of media content. Software modules described herein with respect to subscriber device 100 may have associated hardware or may be installed on specific hardware. In embodiments, any function attributed to any software module described herein may be performed wholly or in part by one or more other software modules.

In the exemplary embodiment shown, subscriber device 100 may include a display module 106 for displaying media content received from media server 300. In embodiments, display module 106 may display media content created and/or stored on subscriber device 100. In embodiments, display module 106 may be configured to display visual images, such as 2D images, e.g., still images or video, or 3D images such as holographic images. Accordingly, display module 106 may be electronically connected with a visual display hardware element, for example, an LCD screen.

In embodiments, subscriber device 100 may include an audio projection module for projection audio media content supplied by media server 300 or stored onboard or generated by subscriber device 100. Such an audio projection module may be configured to cause the operation of a hardware element of subscriber device 100, for example, an audio speaker.

Still referring to FIG. 1A and FIG. 1B, and referring additionally to FIG. 1C, media server 300 is configured receive, store, manipulate and/or transmit for display electronic data corresponding to media content across media distribution network 1000. Media server 300 may include one or more real and/or virtual data servers, such as in a cloud computing environment, so that data can be transmitted between different components of media server 300. Media server 300 or portions thereof may be provided, owned, and/or operated by a single entity, such as a natural person, or a legal entity, such as a company or service.

In embodiments, media server 300 is configured to carry out a series of steps or processes directed to electronic data corresponding to media content transmitted across media distribution network 1000. Such steps may be one or more sets of instructions, rules, boundaries, and/or algorithms, to name a few, that result in the manipulation, modification, and/or transformation of a portion of the electronic data corresponding to media content.

In this regard, the entirety of or portions of media server 300 may be formed of one or more computer systems having one or more computers. The computers may store data in one or more databases stored on storage devices having computer-readable memory. Storage devices can include one or more non-transitory computer readable memory stores 302, such as hard drives, flash memory, tapes, disks, CDs, DVDs, memory cards, server farms, and any hardware necessary to read and/or write to such non-transitory memory, such as disk drives, automatic or robotic disk loaders, CD drives, memory card writers, to name a few. The computers may also have one or more software modules run by one or more processors 304 that are electronically coupled with the non-transitory memory stores 302 of the computers. In embodiments, the software modules may provide user interfaces for interacting (e.g., inputting data and/or receiving data) with a computer system. Accordingly, any of the computers may also include input devices (e.g., keyboards, cameras, touchpads, computer mouse devices, touchscreens, microphones) with accompanying software (e.g., speech-to-text software) and/or display devices (e.g., monitors, touchscreens, projectors (e.g., 2-D, 3-D, and/or holographic projectors to name a few).

In embodiments, any function attributed to any software module described herein may be performed wholly or in part by one or more other software modules. In embodiments, a software module may access a third party system or server to perform the ascribed functions.

As described above, media server 300 transmits data associated with media content between third party media content providers 200a, 200b, 200c . . . 200n and subscriber devices 100a, 100b, 100c . . . 100n. Accordingly, media server 300 includes a publishing module 305 for communication between third party media content providers 200a, 200b, 200c . . . 200n and subscriber devices 100a, 100b, 100c . . . 100n, e.g., publishing module 305 may retrieve media content from one or more of third party media content providers 200a, 200b, 200c . . . 200n and may transmit this media content for display on one or more of subscriber devices 100a, 100b, 100c . . . 100n. In embodiments, media server 300 may be configured to display media content on an electronic device other than a subscriber device, e.g., a computer device capable of accessing a website associated with media server 300 through which a user other than a registered subscriber to a service or product offered by media server may access the same.

In embodiments, publishing module 305 can upload media content onto an outward-facing (e.g., subscriber-facing) platform, for example, a website hosted by a portion of media server 300, or a program product associated media distribution network, for example, a mobile device, browser, and/or tablet application. In this regard, publishing module 305 transmits media content data for viewing on one or more of subscriber devices 100a, 100b, 100c . . . 100n.

In embodiments, publishing module 305 may upload media content onto an outward-facing platform through an electronic device having one or more primary functions other than communication with media server 300, for example, a conventional or networked (e.g.,“smart”) television set. In such embodiments, publishing module 305 may transmit for display media content over a cable or digital television channel.

In embodiments, publishing module 305 may be communicate one or more portions of software code associated with third party media content providers 200a, 200b, 200c . . . 200n, for example, via communication with an application programming interface (API) or other utility made available by third party media content providers 200a, 200b, 200c . . . 200n, such that media content data transmitted to subscriber devices 100a, 100b, 100c . . . 100n may appear in the form of, for example, an embedded video player.

Still referring to FIG. 1A, FIG. 1B, and FIG. 1C, in embodiments, media server 300 may include a media content storage module 310 for storing media content data received from third party media content providers 200a, 200b, 200c . . . 200n. In embodiments, media content storage module 310 may temporarily store, e.g., buffer, portions of media content before transmission to one or more of subscriber devices 100a, 100b, 100c . . . 100n. In embodiments, media server 300 may be devoid of a media content storage module, and may be configured to directly receive media content from third party media content providers 200a, 200b, 200c . . . 200n.

An encoder module 315 may be provided for converting data associated with media content from third party media content providers 200a, 200b, 200c . . . 200n into a format viewable on subscriber devices 100a, 100b, 100c . . . 100n. In this regard, encoder module 315 may transform data associated with media content into one or more output formats suitable for viewing on subscriber devices 100a, 100b, 100c . . . 100n. For example, a video may be encoded for display on an Android device, an iOS device, and/or a Windows device, to name a few. As such, media content such as a video may be encoded into multiple formats, such as .mp4, .mov, and .wmv, to name a few. In embodiments, media content may be encoded in a format optimized for streaming, such as .flv for videos. Streaming portions of media content may provide a preview of not yet downloaded media content. In embodiments, encoder module 315 may output standard and/or high definition versions of media content. In embodiments, media server 300 may be devoid of an encoder module, e.g., media server 300 may be configured to receive, store, and/or transmit data associated with media content in a format determined at the source of generation of the media content, e.g., one or more of user devices 100a, 100b, 100c . . . 100n and/or one or more of third party media content providers 200a, 200b, 200c . . . 200n. In embodiments, media server 300 may optionally bypass encoder module 315 when receiving data associated with media content, e.g., when the received media content originates in a format compatible for display on one or more of subscriber devices 100a, 100b, 100c . . . 100n.

As described herein, media server 300 transmits media content to subscriber devices 100a, 100b, 100c . . . 100n that is determined to be the most popular media content within a given time interval. Popularity of a particular unit of media content may be determined by a number of viewers of the particular unit of media content. In embodiments, additional or alternative factors may be used to determine popularity of media content, as described further herein.

With continued reference to FIG. 1A, FIG. 1B, and FIG. 1C, a count module 320 may be provided with media server 300, and can detect a number of viewers of media content received from one or more of third party media content providers 200a, 200b, 200c . . . 200n, e.g., count module 320 is configured to detect a number of electronic connections between user-operated devices configured for viewing media content on one or more of third party media content providers 200a, 200b, 200c . . . 200n. In embodiments, such user-operated devices configured for viewing media content on one or more of third party media content providers 200a, 200b, 200c . . . 200n may be one or more of subscriber devices 100a, 100b, 100c . . . 100n, or may be devices not associated with media distribution network 1000. Count module 320 may be configured to store and update information relating to the number of viewers of media content at set intervals, for example, at intervals of seconds, minutes, hours, days, and/or weeks, such as at an interval of 1, 2, 3, 4, 5, 10, 15, or 20 minutes, to name a few. In embodiments, count module 320 may continuously update information relating to the number of views of media content on third party media content providers 200a, 200b, 200c . . . 200n, e.g., substantially in real-time.

In embodiments, count module 320 may determine a number of viewers associated with media content from one or more of third party media content providers 200a, 200b, 200c . . . 200n by interfacing with a portion of third party social media content providers 200a, 200b, 200c . . . 200n, for example, an API provided by third party media content providers 200a, 200b, 200c . . . 200n.

In embodiments, a number of viewers of media content may be determined by gathering data periodically published by third party media content providers 200a, 200b, 200c . . . 200n, for example, HTML documents or reports published via HTTP.

In embodiments, count module 320, through an API or other outward-facing software utility, can provide third party media content providers 200a, 200b, 200c . . . 200n with an opportunity to return a number of viewers of a particular unit of media content to media server 300. In embodiments, this may be accomplished through passive detection of a number of electronic connections to a particular unit of media content, for example, a hit counter pixel or remote procedure call (RPC) embedded on a website, program application, or other interactive platform of third party media content providers 200a, 200b, 200c . . . 200n. In embodiments, detection of a number of viewers of a particular media content on a third party media content provider 200a, 200b, 200c . . . 200n may be provided by active feedback by a viewer, for example a “like”, “upvote” or other active-feedback type utility provided to viewers of media content on third party media content providers 200a, 200b, 200c . . . 200n, for example, through a graphic user interface of a computer program product associated with third party media content providers 200a, 200b, 200c . . . 200n.

Still referring to FIG. 1A, FIG. 1B, and FIG. 1C, a ranking module 325 may be provided to apply a ranking algorithm to the data provided by count module 320. For example, a ranking algorithm may modify, e.g., increase or decrease, a value or number associated with a total number of views of a particular unit of media content available from third party media content providers 200a, 200b, 200c . . . 200n as determined by count module 320. In embodiments, a ranking algorithm applied by ranking module 325 may only take into account the number of views of a unit of media content on third party media providers 200a, 200b, 200c . . . 200n and discounts the number of viewers of the unit of media content through media server 300. In such embodiments, such exclusions may be desirable to distinguish viewers that seek out and popularize media content at their source (third party media content providers 200a, 200b, 200c . . . 200n) from viewers that are “fed” units of media content by media server 300 that are inherently already popular by virtue of their being hosted by media server 300.

In embodiments, a ranking algorithm applied by ranking module 325 may exclude a different group of viewers of media content being transmitted across media distribution network 1000, for example, viewers of commercially sponsored or mandatorily-displayed media content on third party media content providers 200a, 200b, 200c . . . 200n.

In embodiments, ranking module 325 may apply a factor in addition to or alternatively to a comparison of a number of views of a particular media content as determined by count module 320, for example, ranking module 325 may apply a score or value to a media content based upon one or more of: number of views, third party media content provider supplying the media content, location, and biographical information of the creator of the media content, to name a few. In this regard, ranking module 325 may manipulate and/or transform data provided by count module 320.

In embodiments, ranking module 325 may be configured to determine a highest number of views of a particular unit of media content within a category or type of media content, for example, topic (e.g., keyword), title, location, and/or creation date, to name a few.

In embodiments, ranking module 325 may be configured to determine a popularity of a particular unit of media content based upon realtime voting statistics provided by users, for example, a number of “likes,” “upvotes,” or other feedback metrics of popularity that may be indicated on a user interface, for example, with a meter or displayed number of stars or other graphic indicator.

In embodiments, ranking module 325 may be configured to determine a popularity of a particular unit of media content based upon a rate of new viewers, “likes,” “upvotes,” and or other feedback metric of popularity such that a trending rate is a factor in the popularity of a particular unit of media content.

In embodiments, ranking module 325 may be configured such the count of a view of a particular unit of media content by one or more particular users associated with subscriber devices 100a, 100b, 100c . . . 100n or other electronic devices connected to media server 300 may be given a higher weight than other users, for example, in the case of an administrator or veteran user. In embodiments, such users may have the ability to vote or have their view of a particular unit of media content be counted where one or more other different types of users may be restricted from voting or may have their view of a particular unit of media content counted to a lesser degree.

In embodiments, ranking module 325 may be configured to increase, decrease, weight, or otherwise modify data retrieved by count module 320 with respect to a particular unit of media content in an instance where one or more tags or metadata associated with the unit of media content is associated with a currently-trending internet topic or ongoing news development.

In embodiments, ranking module 325 may be configured to increase, weight, or otherwise modify data retrieved by count module 320 with respect to a particular unit of media content based upon one or more factors associated with the quality of the particular unit of media content, for example, video steadiness, audio quality, lighting quality, camera perspective, camera model, and/or resolution, to name a few.

In embodiments, ranking module 325 may be configured to increase, weight, or otherwise modify data retrieved by count module 320 with respect to a particular unit of media content based upon one or more factors associated with the enticement provided by the particular unit of media content, which may be determined by, for example, object recognition, speech and/or sound recognition, and/or image recognition software, for example, digital signal processing (DSP) through open or proprietary software. In embodiments, such detection software may detect, for example, voice stress patterns, gunfire, riot noises, explosions, and/or recognize facial and/or speech patterns of public figures or celebrities.

In embodiments, ranking module 325 may be configured to increase, decrease, weight, or otherwise modify data retrieved by count module 320 with respect to a particular unit of media content based upon one or more factors associated with the offensiveness provided by the particular unit of media content, which may be determined by, for example, object recognition, speech and/or sound recognition, and/or image recognition software, for example, digital signal processing (DSP) through open or proprietary software. In embodiments, such detection software may detect, for example, profanity, nudity and/or or other content which may be deemed offensive to one or more users. In embodiments, such data may be used to generate an “adult content” tag or label to be associated with the unit of media content, which may, for example, restrict access to one or more individuals below a threshold age or lacking rights to access the material.

In embodiments, ranking module 325 may be configured to increase, weight, or otherwise modify data retrieved by count module 320 with respect to a particular unit of media content based upon one or more factors associated with the creator of the particular unit of media content, for example, past ratings of media content hosted on media server 300, overall rating, number of friends and/or subscribers, to name a few.

In embodiments, one or more actions of count module 320 and/or ranking module 325 described above may be made available, for example, as a standalone computer application product or through an outward-facing API, to a third party media content provider (for example, a third party media content hosting service, such as YouTube, Vimeo, Ustream, Justin.tv, Stickam, BlogTV, Kyte, Veetle, Yaika, Make.tv, and/or Glomera, to name a few.

In such embodiments, a third party media content provider may be provided with the capability of counting a number of electronic connections with a particular unit of media content (e.g., views) and/or applying a ranking algorithm to such results. In embodiments, a ranking algorithm may include excluding viewers that access a particular unit of media content on a third party media content provider's hosting site or service, so that the popularity of the particular unit of media content is based upon viewership before hosting by the third party media content provider. In this regard, the third party media content provider can determine a “true” popularity of a particular unit of media content without any bias injected by regular viewers of media content on the third party media content provider's hosting site or service (who are more likely than others to view media content of any type on such a site or service, irrespective of any unique qualities of the particular unit of media content).

Media server 300 may be provided with a timer module 330 that instructs count module 320 to update its determination of the number of views associated with media content available from third party media content providers 200a, 200b, 200c . . . 200n. Intervals at which timer module 330 is configured to perform such a check may be at intervals of seconds, minutes, hours, days, and/or weeks, for example, an interval of 1, 2, 3, 4, 5, 10, 15, or 20 minutes, to name a few. In embodiments, timer module 330 may be set to an interval of substantially 0, e.g., timer module 330 may instruct count module 320 to continuously update, e.g., substantially in real-time, its determination of the number of views associated with media content available from third party media content providers 200a, 200b, 200c . . . 200n.

With continued reference to FIG. 1A, FIG. 1B, and FIG. 1C, in embodiments, media server 300 may be configured to transmit multiple concurrent units of media content for display on one or more of media devices 100a, 100b, 100c . . . 100n. Accordingly, media server 300 may include a sorting module 335 for arranging media content being transmitted through media server 300. In such embodiments, sorting module 335 may be provided to separate and/or organize multiple units of media content by, for example, topic (e.g., keyword, such a concerts, talent performances, news, breaking news, documentaries, sports, extreme sports, animals, babies, kids, reality, and/or vacations, to name a few), title, location (such as geographic location or setting, .e.g., beaches or mountains), creation date, and/or device type (such as smartphone, head-mounted displays, or GoPro), to name a few.

In embodiments, sorting module 335 may separate and/or organize multiple units of media content by a status of a user of entity providing media content, e.g., an amateur or professional creator of media content. In embodiments, different user statuses may be detected by sorting module 335, for example, professional or amateur sports teams or government organizations, to name a few.

A status of a user may be determined, for example, through the detection of metadata or other information associated with a unit of media content, for example embedded or overlaid commercial content. In embodiments, a user may designate, e.g., through a filter or switch that can be selected by a viewer on a graphical user interface associated with media server 300, whether to view amateur-created or professionally-created media content.

In this regard, sorting module 335 may separate and/or arrange multiple received units of media content based upon metadata associated with data corresponding to media content received from one or more of third party media content providers 200a, 200b, 200c . . . 200n. In embodiments, each category of media content separated by sorting module 335 may be separately treated by media server 300 as described herein, e.g., collections of media content as separated by sorting module 335 may be subject to determinations of popularity by count module 320 and/or ranking module 325 independently of one another.

In embodiments, media server 300 may include a subscriber module 340 to store information relating to one or more of subscriber devices 100a, 100b, 100c . . . 100n, or to one or more subscribers associated with subscriber devices 100a, 100b, 100c . . . 100n, e.g., a subscriber associated with an account or profile with a website or software application program associated with media server 300. Accordingly, subscriber module 340 may store biographical information such as username, given name, age, date of birth, residence, contact information such as telephone number and/or email address, to name a few. In embodiments, subscriber module 340 may be configured to store information relating to media content accessed by one or more of subscriber devices 100a, 100b, 100c . . . 100n, or to one or more subscribers associated with subscriber devices 100a, 100b, 100c . . . 100n, for example, viewing history, preferences, and/or bookmarks or tags, to name a few.

A communication module 345 may be provided to transmit a notification to one or more of user devices 100a, 100b, 100c . . . 100n upon an event or condition initiated by media server 300. In embodiments, communication module 345 may be configured to alert a user associated with one of subscriber devices 100a, 100b, 100c . . . 100n, for example, when particular media content being transmitted from publishing module 305 is being changed, or when a determination of a most popular media content by media server 300 as determined by count module 320 and/or ranking module 325 has been completed and/or changed.

Still referring to FIG. 1A, FIG. 1B, and FIG. 1C, and with additional reference to FIG. 1D, an exemplary embodiment of a process flow of a process of media server 300 across media distribution network 1000 is illustrated according to an exemplary embodiment of the present disclosure.

In a first step S101, media server 300 connects to one or more of third party media content providers 200a, 200b, 200c . . . 200n to retrieve data associated with media content.

In a second step S102, count module 320 detects a number of views of one or more different types of media content provided by one or more of third party media content providers 200a, 200b, 200c . . . 200n.

As described above, count module 320 determines a number of viewers of various media content available on third party media content providers 200a, 200b, 200c . . . 200n. As described above, such determination of the viewership of media content by the count module 340 may be accomplished, for example, by interfacing with one or more APIs associated with third party media content providers 200a, 200b, 200c . . . 200n, processing viewership data provided by third party media content providers 200a, 200b, 200c . . . 200n, and/or by feedback through an element, such as computer code, embedded within one or more third party media content providers 200a, 200b, 200c . . . 200n such as a remote procedure call (RPC) or embedded counter element.

In a third step S103, ranking module 325 applies a ranking algorithm to the data associated with viewership of media content available from third party media content providers 200a, 200b, 200c . . . 200n retrieved in step S102 above.

In a fourth step S104, publishing module 305 transmits for display the unit of media content associated with the highest number of views as determined by count module 320 and/or ranking module 325 in steps S102 and S103 described above.

In a fifth step S105, timer module 330 instructs count module 320 to update its count of the highest number of views of one or more different types media content provided by one or more of third party media content providers 200a, 200b, 200c . . . 200n. In embodiments, timer module 350 may instruct count module 320 to update its count of the highest number of views during the transmission of media content from publishing module 305 to one or more of subscriber devices 100a, 100b, 100c . . . 100n, or at the completion of such a transmission of media content.

Turning now to FIG. 1E, and with continued reference to FIG. 1A, FIG. 1B, and FIG. 1C, a flow chart of a series of steps of media server 300 is illustrated according to an exemplary embodiment of the present invention. In a first step S201, a process of media server 300 is initiated. The process of media server 300 illustrated may be initiated, for example, upon an initial activation of media server 300, or at or following a designated function of media server 300, for example, completion of a transmission of a unit of media content. Accordingly, first step S201 may additionally include electronically connecting with one or more of third party media content providers 200a, 200b, 200c . . . 200n and/or retrieving media content therefrom.

In a second step S202, sorting module 335 may categorize one or more of multiple distinct units of media content according to one or more distinct units of media content for example, topic (e.g., keyword), title, location, and/or creation date, to name a few. In embodiments, sorting module 335 categorizes media content retrieved from third party media content providers 200a, 200b, 200c . . . 200n into multiple categories. Multiple categories of media content may proceed in parallel through a process of media server 300.

In a third step S203, count module 320 of media server 300 determines a highest number of views associated with media content available from one or more of third party media content providers 200a, 200b, 200c . . . 200n. As described above such determination of the viewership of media content by the count module 320 may be accomplished by, for example, interfacing with one or more APIs associated with third party media content providers 200a, 200b, 200c . . . 200n, processing viewership data provided by the third party media content providers 200a, 200b, 200c . . . 200n, and or by feedback through an element, such as computer code, embedded within one or more third party media content providers 200a, 200b, 200c . . . 200n such as a remote procedure call (RPC) or embedded counter element.

In a step S204a, ranking module 325 may be initiated if media server 300 is configured such that one or more exclusions apply to the number of viewers determined by count module 320 in step S203 above. If ranking module 325 is initiated, the process follows to a step S204b in which media server 300 applies a ranking algorithm to the media content associated with various viewership numbers as retrieved by count module 320 in step S202. Accordingly, ranking module 325 may make a determination as to whether the number of viewers of particular media content as retrieved by count module 320 should be used in designating media content the most popular media content available from third party media content providers 200a, 200b, 200c . . . 200n, or whether this value should be altered under the ranking algorithm.

Following application of the ranking algorithm by ranking module 325, or if ranking module 325 is bypassed, in a step S205, publishing module 305 transmits the most popular media content as determined by count module 320 and/or ranking module 325 to an electronic platform such that the most popular media content can be displayed on the subscriber devices 100a, 100b, 100c . . . 100n, for example, a website hosted by media server 300 or to a computer program application that can be run on subscriber devices 100a, 100b, 100c . . . 100n.

In a step S206, timer module 330 determines whether a predetermined time interval tₙ associated with timer module 330 has elapsed since the start of the process of media server 300, e.g., since step S201. If a time interval t₁ that has elapsed since the start of the process is less than tₙ, then the publishing module 305 continues to transmit media content to subscriber devices 100a, 100b, 100c . . . 100n associated with the most recent count provided by count module 320 and/or ranking module 325 as described above.

However, if the time interval t₁ that has elapsed since the start of the process is greater than or equal to tₙ, then timer module 330 instructs count module 320 (and thereby ranking module 325) to update its count of the number of viewers of the media content available on third party media content providers 200a, 200b, 200c . . . 200n, e.g., the process reverts to step S203.

In various embodiments described herein, in the event that a particular unit of media content has finished transmission, publishing module 305 may proceed to wrap, e.g., end or conclude, transmission through the embedded media player or other application for displaying and/or projecting the particular unit of media content. In embodiments, such a wrap of transmission may be followed by a transitional unit of media content, e.g., a unit of media content associated with media server 300 that may be, for example, a video, graphic, or animation. In embodiments, such a transitional unit of media content may be commercial in nature.

In various embodiments described herein, the wrapping of a particular unit of media content may be followed by the initiation of transmission of another unit of media content, e.g., a unit of media content newly associated with a highest popularity according to count module 320 and/or ranking module 325. Such initiation of transmission of another unit of media content may be include opening a new embedded media player or other application for displaying and/or projecting media content. Such a transition to a new unit of media content may occur during display and/or projection of a previous unit of media content, or may occur at the conclusion of the previous unit of media content. In embodiments, a viewer may be provided with the option, for example, through an input on a graphic user interface, to lock a currently-displayed and/or projected unit of media content until it reaches its conclusion. In embodiments, such an option may be engaged with the input of a “like” or “upvote” feedback relating to a particular unit of media content.

Turning to FIG. 1F, with reference still to FIG. 1A, FIG. 1B, and FIG. 1C, a graphical user display (GUI) associated with one of subscriber devices 100a, 100b, 100c . . . 100n in communication with media server 300 across data network 400 is generally designated 120. Graphical user display 120 may be a portion of a program product associated with media server 300 that is configured for display on subscriber devices 100a, 100b, 100c . . . 100n. Accordingly, graphical user display 120 may be associated with software code read by a processor of one or more of subscriber devices 100a, 100b, 100c . . . 100n and stored on a non-transitory computer-readable storage module of one or more of subscriber devices 100a, 100b, 100c . . . 100n. In embodiments, graphical user display 120, e.g., through encoder module 315, may be associated with software code written and/or formatted for different computer software operating systems, for example, a Windows operating system, an iOS operating system, or a Linux operating system, to name a few.

As shown, a portion of graphical user display 120 is apportioned for displaying a unit of media content 122 transmitted by media server 300. As described above, the unit of media content may be specially formatted for display through graphical user display 120 or may have the form of an embedded video player associated with a third party computer software package.

Graphical user display 120 may include a queue 124 of units of media content 122a, 122b, 122c that are scheduled to play sequentially following the unit of media content 122 currently on display. In embodiments, units of media content 122a, 122b, 122c . . . 122n may be units of media content stored on media content storage module 310, or may be representative of units of media content that are yet-to-be retrieved from third party media content providers 200a, 200b, 200c . . . 200n.

As shown, graphical user display 120 may include links to one or more categories 126a, 126b, 126c . . . 126n associated with units of media content and/or queues of media content, similar to queue 124, that are associated with a particular types of units of media content, for example, units of media content having a common subject matter, keyword, creation date, or creation location, to name a few. In embodiments, stations 126a, 126b, 126c may be created by action of the sorting module 340 described above.

Graphical user display 120 also includes a counter 128 that may display a number of viewers of the unit of media content 122 as determined by count module 320 and/or ranking module 325 of media server 300. In embodiments, counter 128 may display a total number of viewers of a particular unit of media content, e.g., as provided by count module 320, or may present a number of viewers of a particular unit of media content as determined by a ranking algorithm applied by ranking module 325.

A timer 130 may also be included with graphical user display 120, and may indicate, for example, an elapsed time since the start of display of the unit of media content 122. In embodiments, timer 130 may be associated with a different value, for example, an elapsed time since the unit of media content 122 has retained a status of most popular as determined by count module 320 and/or ranking module 325, or a countdown time corresponding to a next unit of media content for display, to name a few. In embodiments, graphical user display 120 may include multiple timer graphics.

Voting graphics 132a, 132b may also be included with graphical user display 120, and may be provided, for example, so that a viewer of the unit of media content 122 can proactively affect the popularity of the unit of media content 122 as determined by count module 320 and/or ranking module 325. In the exemplary embodiment shown, voting graphic 132a may correspond to a “like” or “upvote” of the currently displayed unit of media content 122. Voting graphic 132b may correspond to a “dislike” or “downvote” of the currently displayed unit of media content 122 that may have the effect, for example, of reducing by a value of 1 the count of the number of viewers (and/or other metric) of the unit of media content 122 as determined by count module 320 and/or ranking module 322. In embodiments, graphical user display 120 may be devoid of voting graphic 132b.

As described above, graphical user display 120 may include a locking graphic 134, which initiates an instruction to publishing module 305 to continue display and/or projection of the current unit of media content 122 until it reaches its conclusion. Thus, a next unit of media content 122a or, for example, a different unit of media content that has supplanted the current unit of media content 122 in being designated the most popular unit of media content by count module 320 and/or ranking module 325, may be prevented from being displayed and/or projected by publishing module 305 by the actuation of locking graphic 134.

In embodiments, graphical user display 120 may have a different number and/or arrangement of visual elements as described herein.

Turning to FIG. 1G, and with reference to FIG. 1A, FIG. 1B, and FIG. 1C, an alternative configuration of media distribution network 1000 is illustrated. As shown, media distribution network 1000 includes a number of content creators. Typically such content creators may be individual users I associated with subscriber devices 100a, 100b, 100c . . . 100n. In embodiments, individual users I may be independent of subscriber devices 100.

As shown, individual users I provide media content, e.g., captured media content or individually-created media content, via digital upload to one or more of third party media content providers 200a, 200b, 200c . . . 200n, e.g., across data network 400. Third party media content providers 200a, 200b, 200c . . . 200n, through an outward-facing API, may then provide an embedded computer element for display and/or projection of media content, e.g., an embedded video player, to one or more of subscriber devices 100a, 100b, 100c . . . 100n. In embodiments, an embedded computer element for display and/or projection of media content may be provided to an electronic device other than subscriber devices 100a, 100b, 100c, 100n.

Simultaneously, and as shown, media server 300 may retrieve metadata or other data associated with media content from third party media content providers 200a, 200b, 200c . . . 200n, for example, through an API. Such an API may be web-based, for example, an HTTP API.

Metadata received from third party media content providers 200a, 200b, 200c . . . 200n can then be retrieved by media server 300, which then accumulates and organizes the data, e.g., via sorting module 335 described above. Accumulation and sorting of data retrieved from third party media content providers 200a, 200b, 200c . . . 200n may be controlled, manipulated, and/or otherwise operated at least partially be an administrator associated with media server 300, as shown.

In embodiments, media server 300 may replicate data associated with media content that has been gathered and sorted in the manner described above, for example, through replication of a master storage module M into a secondary storage module S. Master storage module M and secondary storage module S, as shown, may be non-transitory computer-readable mediums upon which one or more instructions can be stored, as described above.

Thereafter, a frontend of media server 300, which may be a computer program application or webpage associated with media server 300, may notify one or more users of a changed event of media server 300, e.g., a change in the ranking of multiple units of media content according to popularity. Such a notification may occur, for example, through a websocket push of data to subscriber devices 100a, 100b, 100c . . . 100n or to other electronic devices connected across data network 400.

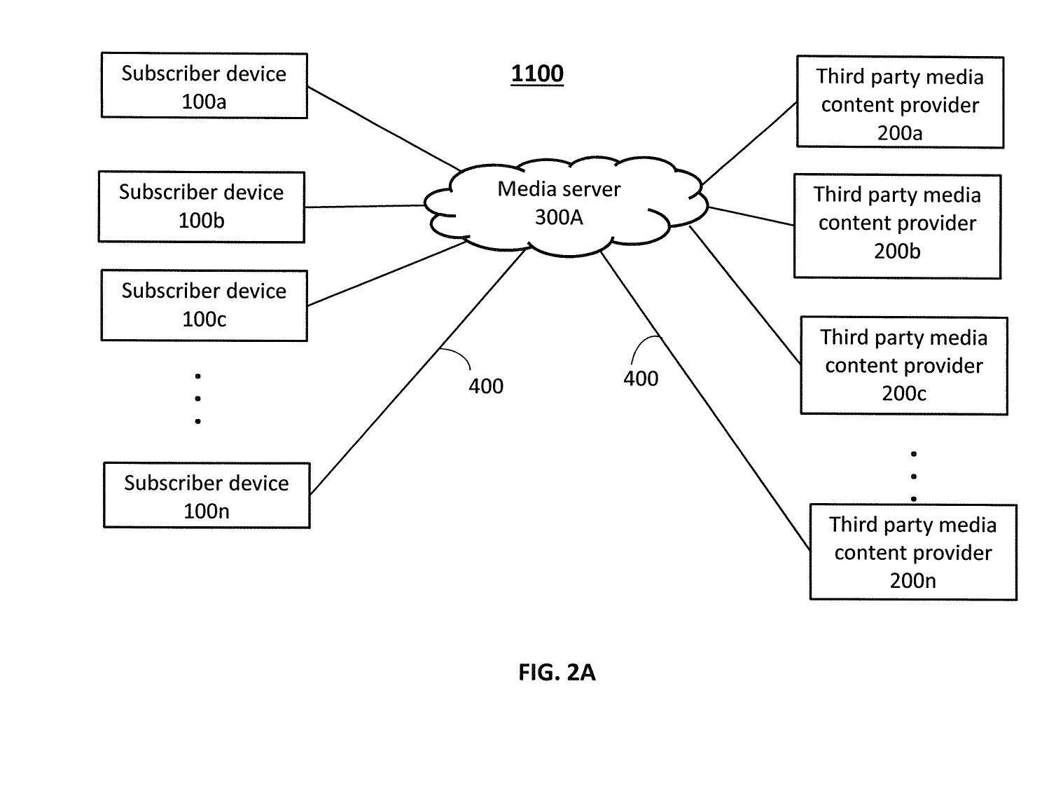

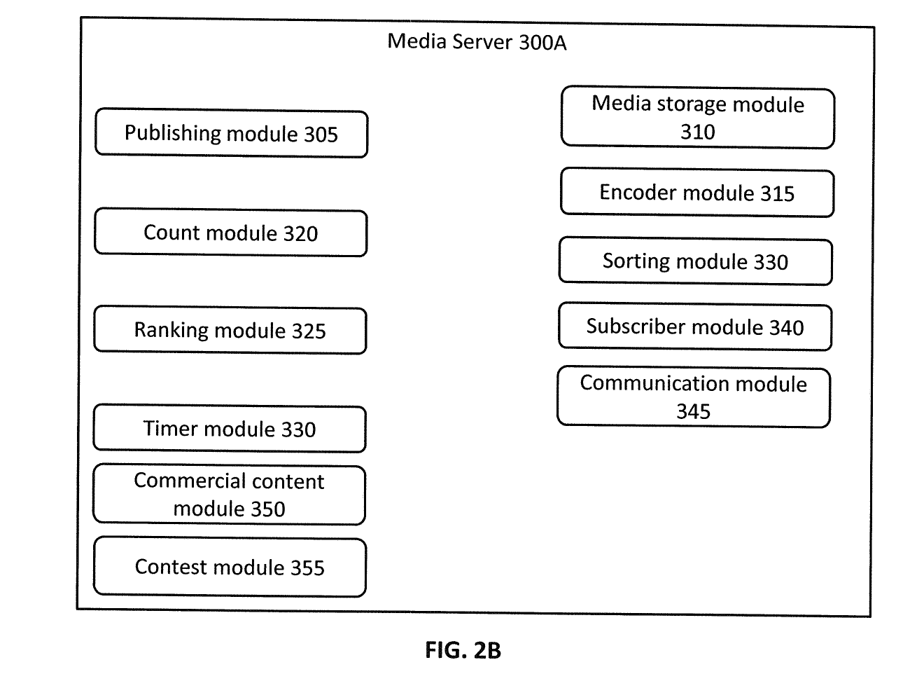

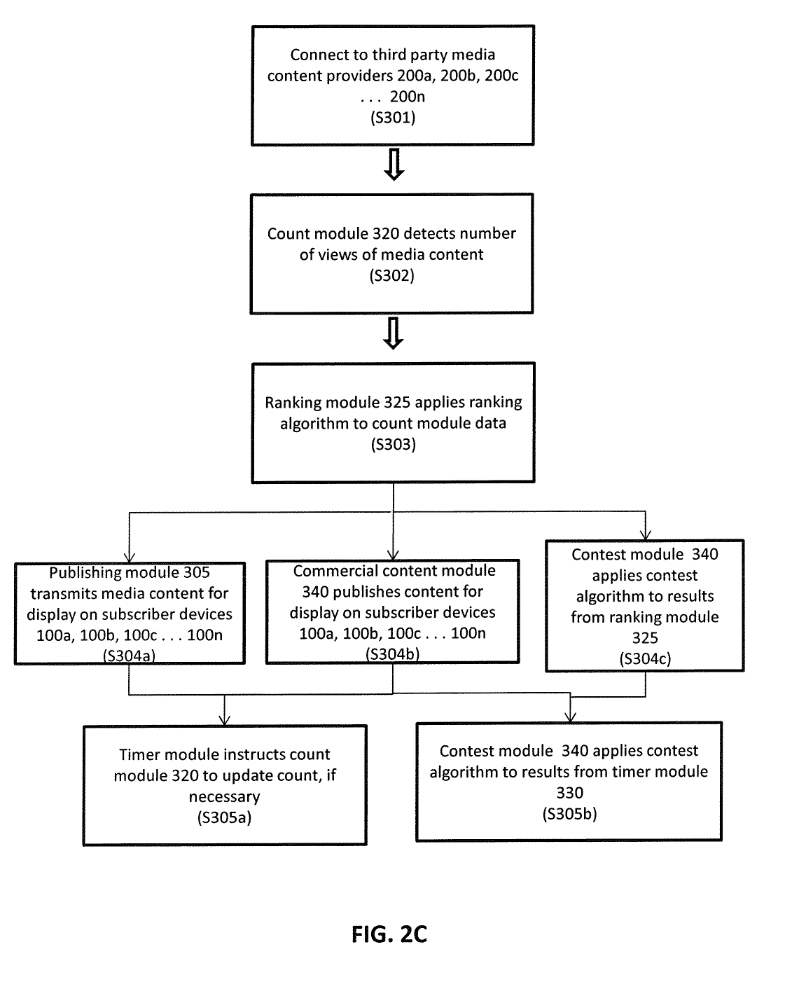

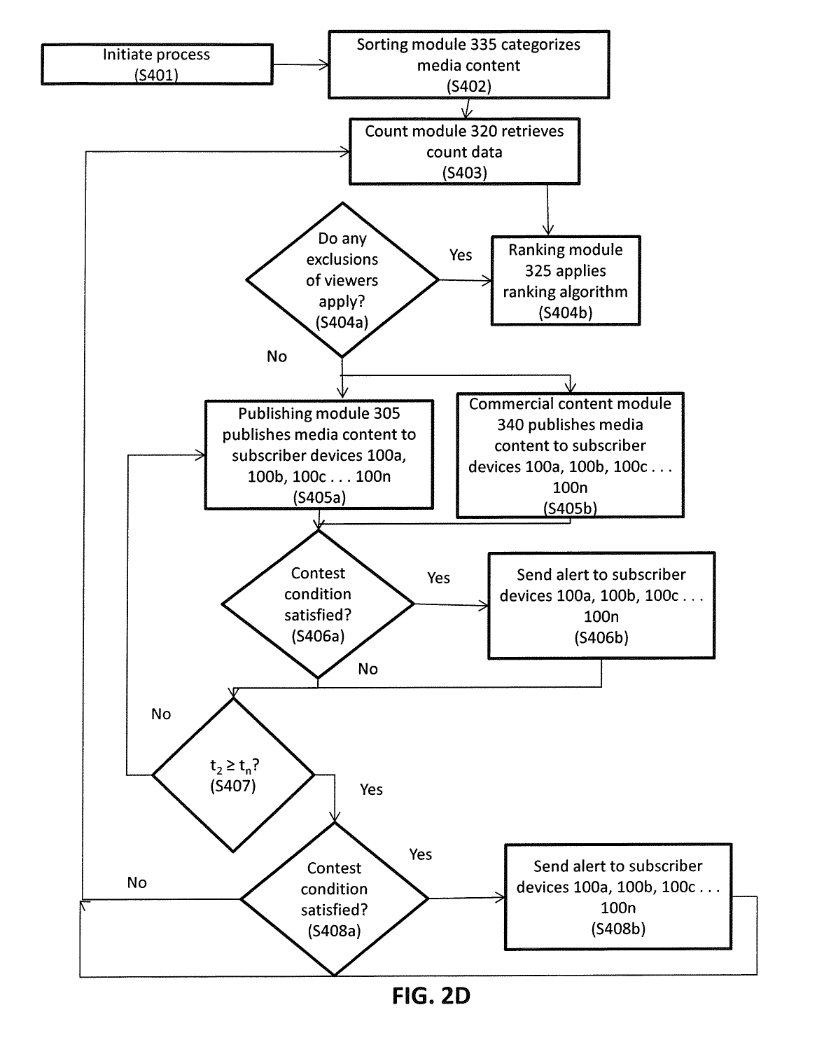

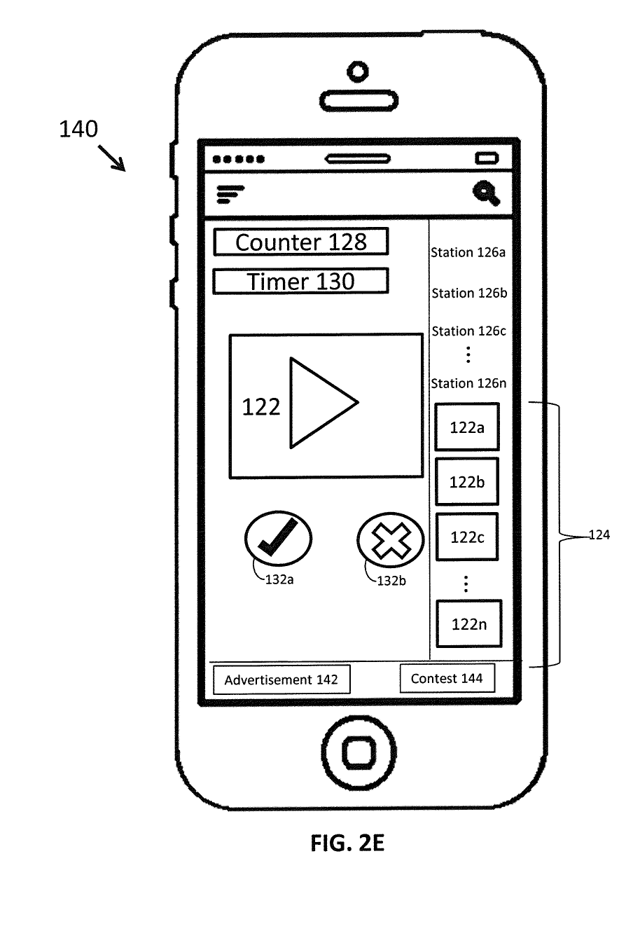

Turning now to FIG. 2A, an alternative embodiment of a media distribution network according to an exemplary embodiment of the present invention is generally designated 1100. Media distribution network 1100 may be similar to media distribution network 1000 described above in that media distribution network 1100 includes the a plurality of subscriber devices 100a, 100b, 100c . . . 100n and the plurality of third party media content providers 200a, 200b, 200c . . . 200n interconnected with a media server 300A across data network 400.

Turning additionally to FIG. 2B, a schematic view of media server 300A is illustrated. Media server 300A may have a similar configuration to media server 300 described above with respect to media distribution network 1000, e.g., media server 300A may include publishing module 305, media content storage module 310, encoder module 315, count module 320, ranking module 325, timer module 330, sorting module 335, subscriber module 340, and/or communication module 345. In embodiments, any function attributed to software modules described herein may be performed wholly or in part by one or more other software modules.

As shown, media server 300A may include a commercial content module 350 that transmits data to subscriber devices 100a, 100b, 100c . . . 100n associated with commercial content module 350 that can be displayed with, for example, overlaid or shown adjacent to, media content transmitted from publishing module 305.

Commercial content module 350 may provide content in the form of audio or visual images, such as logos, icons, still photos, and/or video, to name a few. In embodiments, commercial content module 350 may provide, for example, commercial advertisements that display before, following, and/or concurrently with media content provided by publishing module 305. Content provided by commercial content module 350 may be associated with third party media content providers 200a, 200b, 200c . . . 200n, for example, a commercial entity associated with third party media content providers 200a, 200b, 200c . . . 200n and/or sponsors thereof.

In embodiments, media server 300A may include a contest module 355 that may apply a set of rules or conditions under which a creator of media content being transmitted across media distribution network 1100 may be rewarded with an incentive, e.g., a monetary award and/or a voucher for goods and/or services. In this regard, contest module 355 may apply a contest algorithm to data retrieved by count module 320 and/or ranking module 325 to determine if one or more conditions have been met relating to a contest being offered on media server 300A.

In embodiments, a contest algorithm may be configured to detect a predetermined number of viewers of a particular unit of media content being transmitted by publishing module 305. As described above, the number of viewers of a particular unit of media content may be inclusive or exclusive of a number of viewers of a unit of media content hosted on media server 300A. In embodiments, the number of viewers of a particular unit of media content may be inclusive or exclusive of a different group of viewers, for example, viewers of commercially sponsored or mandatorily-displayed media content on third party media content providers 200a, 200b, 200c . . . 200n.

In embodiments, a contest algorithm may incorporate a predetermined time interval into a contest determination, for example, a predetermined number of viewers (as determined by count module 320 and/or ranking module 325) reached within a predetermined time interval. In embodiments, a predetermined time interval used by a contest algorithm may be, for example, an interval of 1, 2, 3, 4, 5, 10, 15, or 20 minutes, to name a few.

In this regard, contest module 355 applies a contest algorithm to a unit of media content being transmitted by publishing module 305 to determine if one or more conditions relating to a contest have been met. As described above, such conditions may include a total number of viewers of the unit of media content and/or a predetermined time interval associated with the number of viewers of the unit of media content.

If one or more conditions imposed by contest module 355 have been met, a creator of a unit of media content, e.g., a user of a subscriber device 100a, 100b, 100c . . . 100n or a user associated with a third party media content provider 200a, 200b, 200c . . . 200n, may be eligible for an incentive, such as a monetary reward or a voucher for goods and/or services. In embodiments, a monetary award may be calculated by contest module 355 to be a portion of revenue generated by advertiser content published by commercial content module 350, for example, during an interval of time during which a unit of media content is determined to be most popular by count module 320 and/or ranking module 325.

In embodiments, a creator of media content eligible for such an incentive may be a natural person or a legal entity such as a company. In embodiments, the contest algorithm may be configured to discount a number of viewers associated with an ineligible creator of media content, or may be configured to ignore, e.g., bypass, media content created by an ineligible creator of media content.

Still referring to FIG. 2A and FIG. 2B, and with additional reference to FIG. 2C, an exemplary embodiment of a process flow of a process of media server 300A across media distribution network 1100 is illustrated according to an exemplary embodiment of the present disclosure.

In a first step S301, media server 300 connects to one or more of third party media content providers 200a, 200b, 200c . . . 200n to retrieve data associated with media content.

In a second step S302, count module 320 detects a number of views of one or more different types of media content provided by one or more of third party media content providers 200a, 200b, 200c . . . 200n.

As described above, count module 320 determines a number of viewers of various media content available on third party media content providers 200a, 200b, 200c . . . 200n. As described above such determination of the viewership of media content by the count module 320 may be accomplished by, for example, interfacing with one or more APIs associated with third party media content providers 200a, 200b, 200c . . . 200n, processing viewership data provided by the third party media content providers 200a, 200b, 200c . . . 200n, and or by feedback through an element, such as computer code, embedded within one or more third party media content providers 200a, 200b, 200c . . . 200n such as a remote procedure call (RPC) or embedded counter element.

In a third step S303, ranking module 325 applies a ranking algorithm to the data associated with viewership of media content available from third party media content providers 200a, 200b, 200c . . . 200n retrieved in step S302 above.

In a step S304a, publishing module 305 transmits for display the unit of media content associated with the highest number of views as determined by count module 320 and/or ranking module 325 in steps S302 and S303 described above. In the exemplary embodiment described herein, a step S304b may proceed in parallel with step S304a and transmit for display data provided by commercial content module 350 for display with, e.g., adjacent to or overlaid upon, media content provided by third party media content providers 200a, 200b, 200c . . . 200n.

An optional step S304c may proceed in parallel with steps S304a and S304b to determine if a condition imposed by contest module 355 has been met following the determination by count module 320 and/or ranking module 325 of the popularity of a unit of media content.

In a step S305a, timer module 330 instructs count module 320 to update its count of the highest number of views of one or more different types media content provided by one or more of third party media content providers 200a, 200b, 200c . . . 200n. In embodiments, timer module 330 may instruct count module 320 to update its count of the highest number of views during the transmission of media content from publishing module 305 to one or more of subscriber devices 100a, 100b, 100c . . . 100n, or at the completion of such a transmission of media content.

An optional step S305b may proceed in parallel with steps S305a and S305b to determine if a condition imposed by contest module 355 has been met following the determination by count module 320 and/or ranking module 325 of the popularity of a unit of media content. In embodiments, step S305b may also include transmitting for display an alert to one or more of subscriber devices 100a, 100b, 100c . . . 100n relating to a contest condition, e.g., through communication module 345.

Turning now to FIG. 2D, and with continued reference to FIG. 2A, FIG. 2B, and FIG. 2C, a flow chart of a series of steps of media server 300A is illustrated according to an exemplary embodiment of the present invention.

In a first step S401, a process of media server 300 is initiated. The process of media server 300A illustrated may be initiated, for example, upon an initial activation of media server 300A, or at or following a designated function of media server 300A, for example, completion of a transmission of a unit of media content. Accordingly, first step S401 may additionally include electronically connecting with one or more of third party media content providers 200a, 200b, 200c . . . 200n and/or retrieving media content therefrom.

In a second step S402, sorting module 335 may categorize one or more of multiple distinct units of media content by, for example, topic (e.g., keyword), title, location, and/or creation date, to name a few. In the exemplary embodiment shown, sorting module 335 categorizes media content retrieved from third party media content providers 200a, 200b, 200c . . . 200n into multiple categories. Multiple categories of media content may proceed in parallel through a process of media server 300A.

In a third step S403, count module 320 of media server 300A determines a highest number of views associated with media content available from one or more of third party media content providers 200a, 200b, 200c . . . 200n. As described above, such determination of the viewership of media content by the count module 320 may be accomplished by, for example, interfacing with one or more APIs associated with third party media content providers 200a, 200b, 200c . . . 200n, processing viewership data provided by the third party media content providers 200a, 200b, 200c . . . 200n, and or by feedback through an element, such as computer code, embedded within one or more third party media content providers 200a, 200b, 200c . . . 200n such as a remote procedure call (RPC) or embedded counter element.

In a step S404a, ranking module 325 may be initiated if media server 300A is configured such that one or more exclusions apply to the number of viewers determined by count module 320 in step S403 above. If ranking module 325 is initiated, the process follows to a step S404b in which media server 300 applies a ranking algorithm to the media content associated with various viewership numbers as retrieved by count module 320 in step S403. Accordingly, ranking module 325 may make a determination as to whether the number of viewers of particular media content as retrieved by count module 320 should be used in designating media content the most popular media content available from third party media content providers 200a, 200b, 200c . . . 200n, or whether this value should be altered under the ranking algorithm.

Following application of the ranking algorithm by ranking module 325, or if ranking module 325 is bypassed, in a step S405a, publishing module 305 transmits the most popular media content as determined by count module 320 and/or ranking module 325 to an electronic platform such that the most popular media content can be displayed on the subscriber devices 100a, 100b, 100c . . . 100n, for example, a website hosted by media server 300 or to a computer program application that can be run on subscriber devices 100a, 100b, 100c . . . 100n.

In embodiments, a step S405b may proceed in parallel with step S405a in which commercial content module 340 transmits for display commercial media content to one or more of subscriber devices 100a, 100b, 100c . . . 100n.

In an optional step S406a, contest module 355 may apply a contest algorithm to data provided by count module 320 to determine whether a contest condition has been met. If a contest condition has been met, in a step S406b, contest module 355, via communication module 345, may alert one or more of subscriber devices 100a, 100b, 100c . . . 100n to a changed status of a contest condition. If a contest condition has not been met, or following step S406b, the process continues to step S407.

In a step S407, timer module 330 determines whether a predetermined time interval tₙ associated with timer module 330, has elapsed since step S401. If the time t₂ that has elapsed is less than the time interval tₙ, then the publishing module 305 continues to transmit media content to subscriber devices 100a, 100b, 100c . . . 100n associated with the most recent count provided by count module 320 and/or ranking module 325, as described above.

However, if the time interval t₂ that has elapsed is greater than or equal to tₙ, then the process may proceed to an optional step S408a as described below. In embodiments, if the time interval t₂ that has elapsed is greater than or equal to tₙ, then the process may directly revert to step S403.

In an optional step S408a, contest module 355 may apply a contest algorithm to data provided by count module 320, ranking module 325, and/or timer module 330 to determine whether a contest condition has been met. If a contest condition has been met, in a step S408b contest module 355, via communication module 345, may alert one or more of subscriber devices 100a, 100b, 100c . . . 100n to a changed status of a contest condition. If a contest condition has not been met, the process reverts to steps S405a and/or S405b for continuation of the transmission for display of the current unit of media content.

Still referring to FIG. 2A, FIG. 2B, and FIG. 2C, and with additional reference to FIG. 2E, a graphic user interface 140 associated with one of subscriber devices 100a, 100b, 100c . . . 100n in communication with media server 300A across data network 400 is generally designated 140. Graphical user display 140 may be a portion of a program product associated with media server 300A that is configured for display on subscriber devices 100a, 100b, 100c . . . 100n. Accordingly, graphical user display 120 may be associated with software code read by a processor of one or more of subscriber devices 100a, 100b, 100c . . . 100n and stored on a non-transitory computer-readable storage module 102 (FIG. 1B) of one or more of subscriber devices 100a, 100b, 100c . . . 100n. In embodiments, graphical user display 140 may be associated with software code written and/or formatted for different computer software operating systems, for example, a Windows operating system, an iOS operating system, or a Linux operating system, to name a few.

Graphical user display 140 may include similar elements to graphical user display 120 described above with respect to media server 300, for example, graphical user display 140 may include a currently displayed unit of media content 122, a queue 124 of upcoming unit of media content for display on graphical user display 140, categories 126a, 126b, 126c . . . 126n of media content, a counter 128, timer 130, voting graphics 132a, 132b, and locking graphic 134, as shown.

Graphical user display 140 may also include one or more advertiser graphics 142 for displaying content from commercialization module 350. As described above, one or more advertiser graphic 142 may be overlaid and/or displayed adjacent to the displayed unit of media content 122 on graphic user display 140.

Graphical user display 140 may also include one or more contest graphics 144 for displaying content provided by contest module 355. In embodiments, contest graphic 144 may relate to a currently-offered incentive via a third party advertiser or sponsor. In embodiments, contest graphic 144 may include a changing display of an incentive associated with the currently displayed unit of media content 122, for example, an updating monetary amount or percentage of advertiser revenue being offered.

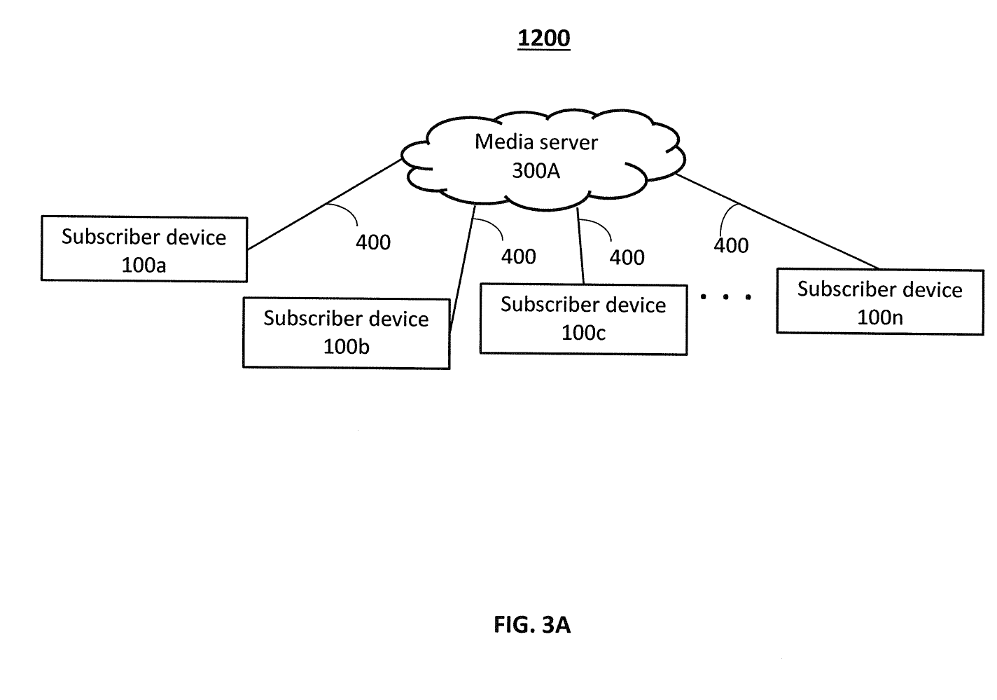

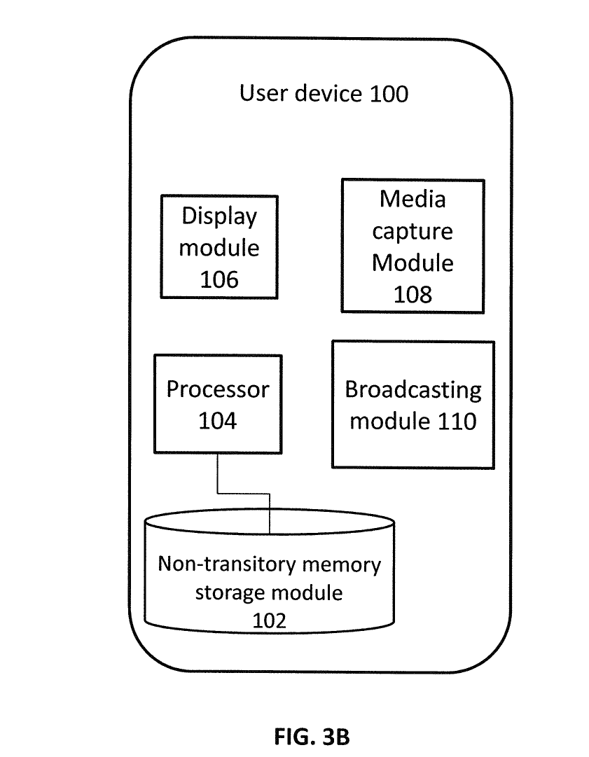

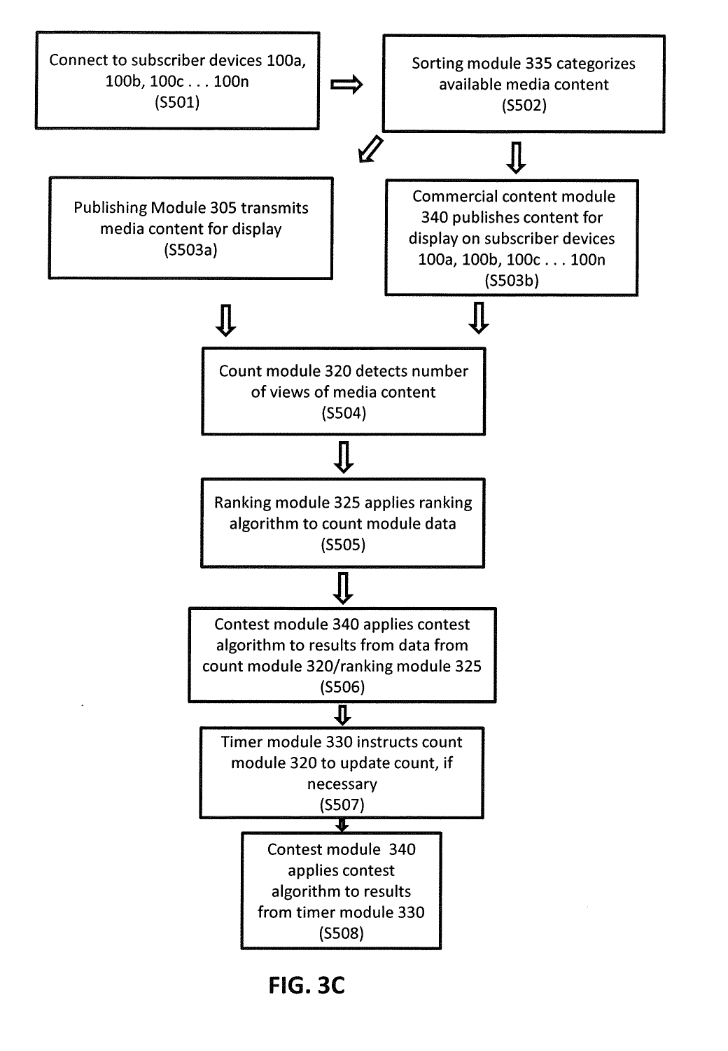

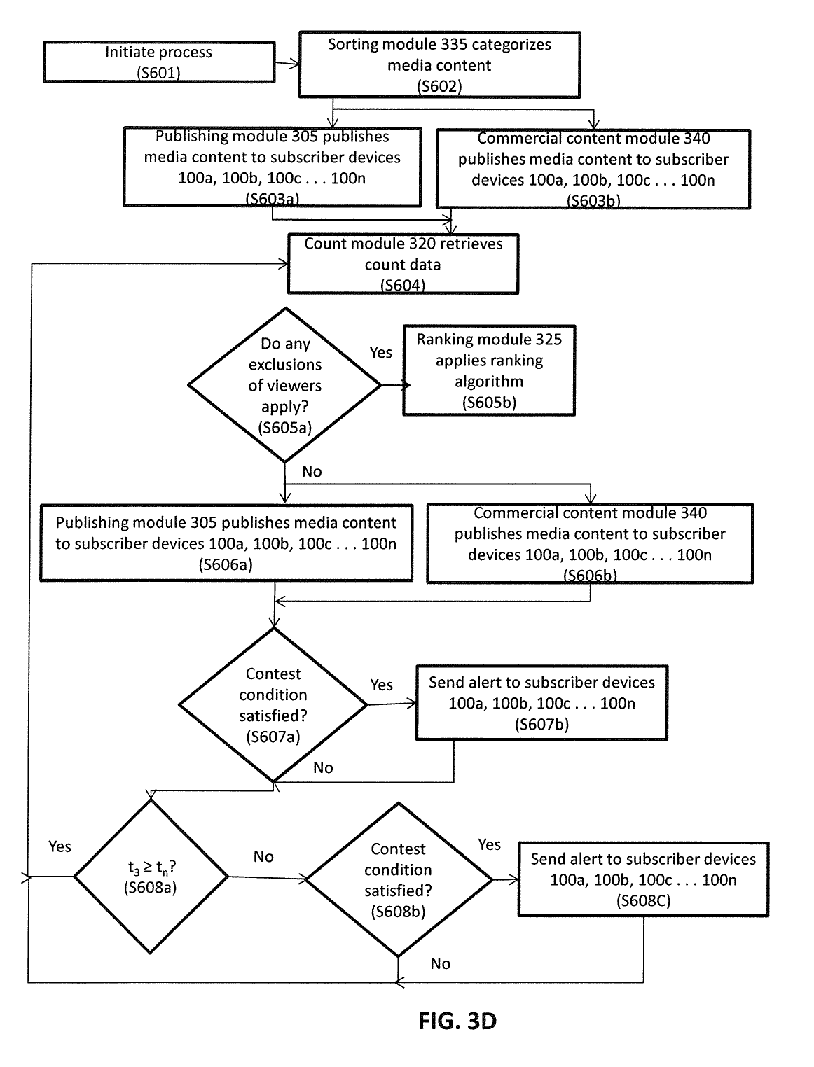

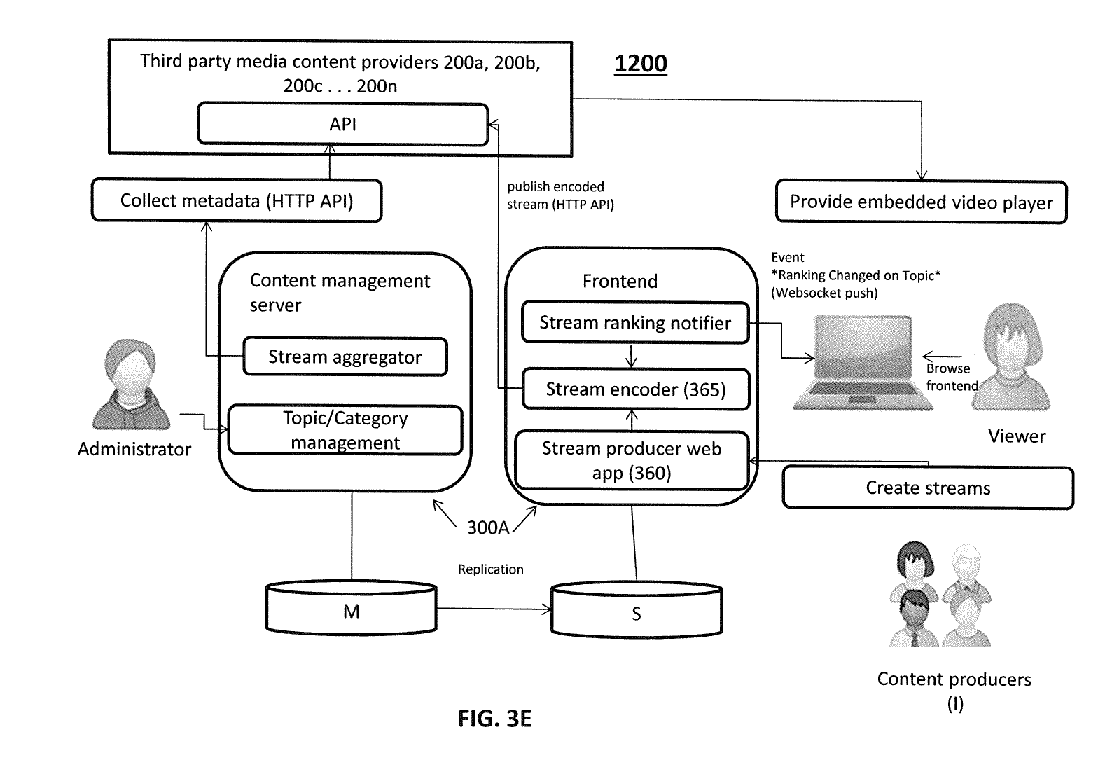

Turning now to FIG. 3A, an alternative embodiment of a media distribution network according to an exemplary embodiment of the present invention is generally designated 1200. Media distribution network 1200 may be similar to media distribution network 1000 or 1100 described above in that media distribution network 1200 includes a plurality of subscriber devices 100a, 100b, 100c . . . 100n interconnected with a media server 300A across data network 400. In embodiments, it will be understood that either media server 300 or media server 300A may be used along media distribution network 1200.

Media distribution network 1200 may be configured such that one or more of subscriber devices 100a, 100b, 100c . . . 100n may generate and/or upload media content to media server 300A. In embodiments, subscriber devices 100a, 100b, 100c . . . 100n may generate and/or transmit media content in addition to third party media content providers 200a, 200b, 200c . . . 200n. In embodiments, one or more of subscriber devices 100a, 100b, 100c . . . 100n may generate and transmit media content to one or more of third party media content providers 200a, 200b, 200c . . . 200n which in turn transmit the media content to media server 300A in the manner described above with respect to media distribution networks 1000 and 1100.

In this regard, media distribution network 1200 is configured such that a user operating one of subscriber devices 100a, 100b, 100c . . . 100n who is a live witness to an event may capture such an event as media content and upload one or more units of media content to the media distribution network 1200 so that the one or more units of media content can be rated by the community of users operating subscriber devices 100a, 100b, 100c . . . 100n. In this regard, media distribution network 1200 takes advantage of the recent proliferation of subscriber devices (e.g., smartphones) that enable users to witness and capture live events as media content by offering such users the opportunity to quickly present this media content before a community of viewers, e.g., for personal gratification and/or for financial incentive.

Turning to FIG. 3B, and still referring to FIG. 3A, a schematic diagram of subscriber device 100 is illustrated according to an exemplary embodiment of the present invention for use with media distribution network 1200. Subscriber device 100 may be similarly configured to subscriber device 100 as described above with respect to media distribution network 1000, e.g., subscriber device 100 includes one or more non-transitory storage mediums 102 upon which instructions or other software code can be read by one or more processors 104. Subscriber device 100 may include a display module 106 as described above to facilitate the display of media content data received from media server 300A. In embodiments, subscriber device 100 may have a different configuration.

In the exemplary embodiment shown, subscriber device 100 includes a media capture module 108. Media capture module 108 is configured to transform physical inputs, e.g., detectable light and/or sound, into data to form electronic media content. In embodiments, media capture module 108 may be electronically connected with a hardware sensor configured to detect light, for example a camera and/or a hardware sensor configured to detect sounds, for example, a microphone. In embodiments, subscriber device 100 may be configured to generate media content without the need for a physical input, for example, through the use of computer-generated images and/or audio, for example, an animation software program. In embodiments, subscriber device 100 may generate media content through a combination of capturing of physical inputs as described above as well as the use of computer-generated images and/or audio. In embodiments, subscriber device 100 may contain software to manipulate media content generated through the capture of physical inputs, for example, a filter applied to an image captured by subscriber device 100.

Subscriber device 100 may also include a broadcasting module 110 that can transmit media content generated on subscriber device 100 to media server 300A. In embodiments, broadcasting module 110 may also tag or otherwise associate identifying information, e.g., metadata, with broadcasting module 110 such that media content being transmitted from subscriber device 100 may be appropriately redirected across media server 300A, e.g., by sorting module 335.

Referring to FIG. 2B, FIG. 3A, and FIG. 3B, and with additional reference to FIG. 3C, an exemplary embodiment of a process flow of a process of media server 300A across media distribution network 1100 is illustrated according to an exemplary embodiment of the present disclosure.

In a first step S501, media server 300A connects to one or more of subscriber devices 100a, 100b, 100c . . . 100n to receive media content generated therefrom. In embodiments, media server 300A may include a software module for interfacing with the broadcasting module 110 of one or more of subscriber devices 100a, 100b, 100c . . . 100n.

In a second step S502, sorting module 335 may categorize one or more of multiple distinct units of media content according to one or more distinct units of media content for example, topic (e.g., keyword), title, location, and/or creation date, to name a few. In embodiments, sorting module 335 may categorizes media content retrieved from subscriber devices 100a, 100b, 100c . . . 100n into multiple categories that may proceed in parallel through a process of media server 300A.

In a step S503a, publishing module 305 transmits media content data supplied from the one or more subscriber devices 100a, 100b, 100c . . . 100n to an electronic platform, for example, a website hosted by media server 300A or to a computer application program that can be run on subscriber devices 100a, 100b, 100c . . . 100n.

In the exemplary embodiment described herein, a step S503b may proceed in parallel with step S503a and transmit for display data provided by commercial content module 350 for display with, e.g., adjacent to or overlaid upon, media content provided by subscriber devices 100a, 100b, 100c . . . 100n.

In a step S504, count module 320 detects a number of views of one or more different types of media content provided by subscriber devices 100a, 100b, 100c . . . 100n.

Because media content is being generated and transmitted from subscriber devices 100a, 100b, 100c . . . 100n in media distribution network 1000, count module 320 determines a number of viewers of various media content on an electronic platform associated with media server 300A, for example, a website hosted by media server 300A or a computer application that can be run on subscriber devices 100a, 100b, 100c . . . 100n.

In a step S505, ranking module 325 applies a ranking algorithm to the data associated with viewership of media content available from subscriber devices 100a, 100b, 100c . . . 100n retrieved in step S504 above.

In an optional step S506, a determination may be made whether a condition imposed by contest module 355 has been met following the determination by count module 320 and/or ranking module 325 of the popularity of a unit of media content.

In a step S507, timer module 330 instructs count module 320 to update its count of the highest number of views of one or more different types media content provided by one or more of subscriber devices 100a, 100b, 100c . . . 100n. In embodiments, timer module 330 may instruct count module 320 to update its count of the highest number of views during the transmission of media content from publishing module 305 to one or more of subscriber devices 100a, 100b, 100c . . . 100n, or at the completion of such a transmission of media content.

In an optional step S508, a determination may be made whether a condition imposed by contest module 355 has been met following the determination by count module 320 and/or ranking module 325 of the popularity of a unit of media content in view of the data provided by timer module 330.

Turning now to FIG. 3D, and with continued reference to FIG. 2B, FIG. 3A and FIG. 3B, a flow chart of a series of steps of media server 300A is illustrated according to an exemplary embodiment of the present invention.

In a first step S601, a process of media server 300A is initiated. The process of media server 300A illustrated may be initiated, for example, upon an initial activation of media server 300A, or at or following a designated function of media server 300A, for example, completion of a transmission of a unit of media content. Accordingly, first step S601 may additionally include electronically connecting with one or more of subscriber devices 100a, 100b, 100c . . . 100n and/or retrieving media content therefrom.

In a second step S602, sorting module 335 may categorize one or more of multiple distinct units of media content according to one or more distinct units of media content for example, topic (e.g., keyword), title, location, and/or creation date, to name a few. In embodiments, sorting module 335 may categorizes media content retrieved from subscriber devices 100a, 100b, 100c . . . 100n into multiple categories that may proceed in parallel through a process of media server 300A.

In a step S603a, publishing module 305 transmits media content data supplied from the one or more subscriber devices 100a, 100b, 100c . . . 100n to an electronic platform, for example, a website hosted by media server 300A or to a computer application program that can be run on subscriber devices 100a, 100b, 100c . . . 100n.

In the exemplary embodiment described herein, a step S603b may proceed in parallel with step S603a and transmit for display data provided by commercial content module 350 for display with, e.g., adjacent to or overlaid upon, media content provided by subscriber devices 100a, 100b, 100c . . . 100n.

In a step S604, count module 320 of media server 300A determines a highest number of views associated with media content available from one or more of subscriber devices 100a, 100b, 100c . . . 100n.

In a step S605a, ranking module 325 may be initiated if media server 300A is configured such that one or more exclusions apply to the number of viewers determined by count module 320 in step S604 above. If ranking module 325 is initiated, the process follows to a step S605b in which media server 300A applies a ranking algorithm to the media content associated with various viewership numbers as retrieved by count module 320 in step S604. Accordingly, ranking module 325 may make a determination as to whether the number of viewers of particular media content as retrieved by count module 320 should be used in designating media content the most popular media content available from subscriber devices 100a, 100b, 100c . . . 100n, or whether this value should be altered under the ranking algorithm.

In an optional step S606a, contest module 355 may apply a contest algorithm to data provided by count module 320 and/or ranking module 325 to determine whether a contest condition has been met. If a contest condition has been met, in a step S606b, contest module 355, via communication module 345, may alert one or more of subscriber devices 100a, 100b, 100c . . . 100n to a changed status of a contest condition. If a contest condition has not been met, or following step S606b, the process continues to step S607.

In a step S607, timer module 330 determines whether a predetermined time interval tₙ associated with timer module 330, has elapsed since step S601. If the time t₃ that has elapsed is less than the time interval tₙ, then the publishing module 305 continues to transmit media content to subscriber devices 100a, 100b, 100c . . . 100n associated with the most recent count provided by count module 320 and/or ranking module 325, as described above.

However, if the time interval t₃ that has elapsed is greater than or equal to tₙ, then the process may proceed to an optional step S609a as described below. In embodiments, if the time interval t₃ that has elapsed is greater than or equal to tₙ, then the process may directly revert to step S604.

In an optional step S609a, contest module 355 may apply a contest algorithm to data provided by count module 320, ranking module 325, and/or timer module 330 to determine whether a contest condition has been met. If a contest condition has been met, in a step S609b contest module 355, via communication module 345, may alert one or more of subscriber devices 100a, 100b, 100c . . . 100n to a changed status of a contest condition. If a contest condition has not been met, the process reverts to steps S603a and/or S603b for continuation of the transmission for display of the current unit of media content.

Turning to FIG. 3E, and with reference to FIG. 2B, FIG. 3A, FIG. 3B, and FIG. 1C, an alternative configuration of media distribution network 1200 is shown. As shown, media distribution network 1200 includes a number of individual content creators I. Content creators I may be individual users associated with subscriber devices 100a, 100b, 100c . . . 100n. In embodiments, individual users I may be independent of subscriber devices 100a, 100b, 100c . . . 100n.

As shown, individual users I provide media content, e.g., captured media content or individually-created media content, via digital upload to media server 300A, e.g., across data network 400. Media server 300A, as shown, may include a stream producer application module 360, which may be configured to receive, format, and/or publish media content to one or more third party media content providers 200a, 200b, 200c . . . 200n. Stream producer application module 360 may be accessed on a frontend of media server 300A, which may be a computer program application or webpage associated with media server 300A.

As shown, media server 300A may also include a media content encoder 365, which may be configured to provide to transmit for display data with one or units of media content. In embodiments, media content encoder 365 may be configured to provide, for example, statistics, commercial advertisements, and/or other information for display and/or transmission with media content. It will be understood that media distribution network 1200 according to the present embodiment may optionally be devoid of media content encoder 365.

Third party media content providers 200a, 200b, 200c . . . 200n, through an outward-facing API, may then provide an embedded computer element for display and/or projection of media content, e.g., an embedded video player, to one or more of subscriber devices 100a, 100b, 100c . . . 100n. In embodiments, an embedded computer element for display and/or projection of media content may be provided to an electronic device other than subscriber devices 100a, 100b, 100c, 100n.

Simultaneously, and as shown, media server 300A may retrieve metadata or other data associated with media content from third party media content providers 200a, 200b, 200c . . . 200n, for example, through an API. Such an API may be web-based, for example, an HTTP API.

Metadata received from third party media content providers 200a, 200b, 200c . . . 200n can then be retrieved by media server 300A, which then accumulates and organizes the data, e.g., via sorting module 335 described above. Accumulation and sorting of data retrieved from third party media content providers 200a, 200b, 200c . . . 200n may be controlled, manipulated, and/or otherwise operated at least partially be an administrator associated with media server 300A, as shown.

In embodiments, media server 300A may replicate data associated with media content that has been gathered and sorted in the manner described above, for example, through replication of a master storage module M into a secondary storage module S. Master storage module M and secondary storage module S, as shown, may be non-transitory computer-readable mediums upon which one or more instructions can be stored, as described above.

Thereafter, the frontend of media server 300A may notify one or more users of a changed event of media server 300A, e.g., a change in the ranking of multiple units of media content according to popularity. Such a notification may occur, for example, through a websocket push of data to subscriber devices 100a, 100b, 100c . . . 100n or to other devices connected to the media distribution network 1200 across data network 400.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A media server, comprising:
one or more processors;
one or more modules of non-transitory computer-readable memory upon which a set of instructions are stored, the one or more modules of non-transitory computer-readable memory electronically coupled with the one or more processors to implement at least one instruction of the set of instructions;
a count module configured to determine a number of electronic connections associated with a plurality of units of media content;
a publishing module configured to transmit for display a unit of media content of the plurality of units of media content associated with a highest number of electronic connections onto one or more subscriber devices of a plurality of subscriber devices electronically connected to the media server; and
a timer module configured to instruct the count module to update a determination of a number of electronic connections associated with the plurality of units of media content at one or more predetermined intervals.

2. The media server of claim 1, further comprising a ranking module configured to modify count data output by the count module.

3. The media server of claim 1, wherein the ranking module is configured to apply a ranking algorithm to modify count data output by the count module.

4. The media server of claim 3, wherein the ranking algorithm is configured to exclude one or more electronic connections from a determination of the count module.

5. The media server of claim 1, further comprising an encoder module configured to convert the at least one unit of media content of the plurality of units of media content from a first format to a second, different format.

6. The media server of claim 1, further comprising a media storage module configured to store at least one unit of media content of the plurality of units of media content.

7. The media server of claim 1, further comprising a sorting module configured to assign at least one unit of media content of the plurality of units of media content to one or more category.

8. The media server of claim 7, wherein the sorting module is configured to assign at least one unit of media content of the plurality of units of media content to one or more category based upon metadata associated with the at least one unit of media content.

9. The media server of claim 7, wherein the one or more category is chosen from a group consisting of: title, keyword, genre, creation date, creation location, and length.

10. The media server of claim 1, further comprising a communication module for sending a notification to at least one subscriber device of the plurality of subscriber devices.

11. The media server of claim 1, wherein the plurality of subscriber devices is electronically connected with the media server across a data network.

12. The media server of claim 1, wherein at least one predetermined time interval of the one or more predetermined time intervals is 15 minutes.

13. The media server of claim 1, wherein the count module is configured to retrieve count data associated with a number of electronic connections associated with a unit of media content from one or more third party media content providers.

14. The media server of claim 1, further comprising a commercial content module configured to transmit for display one or more units of commercial media content adjacent to the at least one unit of media content.

15. A computer-implemented method, comprising:
(a) retrieving, by a media server having one or more processors configured to read one or more instructions of a set of instructions stored on a non-transitory computer-readable medium, a plurality of units of media content;
(b) determining, by a count module of the media server, a number of electronic connections to each unit of media content of the plurality of units of media content; and
(c) transmitting, by a publishing module of the media server, a unit of media content having the highest number of electronic connections for display on at least one subscriber device electronically connected to the media server.

16. The computer-implemented method of claim 15, further comprising the step of applying, by a ranking module of the media server, a ranking algorithm to transform data associated with a determination by the count module of the media server.

17. The computer-implemented method of claim 16, wherein the ranking algorithm includes excluding one or more electronic connections from a determination by the count module of the media server.
